(19) United States
(12) Patent Application Publication
(10) Pub. No.: US 2024/0191424 A1
(43) Pub. Date: Jun. 13, 2024

(54) Particulate Separation System for Laundry Dryer

(71) Applicant: Alliance Laundry Systems LLC, Ripon, WI (US)

(72) Inventors: Andrew Kegler, Ripon, WI (US); Stephen Lester Harris, Oshkosh, WI (US); Todd Jonathan Zellmer, Ripon, WI (US); Karl Fredrick Schwengel, Oakfield, WI (US); Debra A. Eiler, Brandon, WI (US); Michael J. Zambrowicz, Ripon, WI (US); Aaron Benjamin Dollevoet, Berlin, WI (US); Andrew Mason Harris, Oshkosh, WI (US)

(73) Assignee: Alliance Laundry Systems LLC, Ripon, WI (US)

(21) Appl. No.: 18/490,300

(22) Filed: Oct. 19, 2023

Related U.S. Application Data
(60) Provisional application No. 63/386,370, filed on Dec. 7, 2022.

(51) Int. Cl. D06F 58/22; B01D 45/16; B04C 3/04; B04C 3/06

(52) U.S. Cl. CPC D06F 58/22; B01D 45/16; B04C 3/04; B04C 3/06; B04C 2003/006

(57) ABSTRACT

A cyclone filter includes a body including a cylindrical surface extending between a first end and a second end, and defining a cavity of the cyclone filter. An air inlet is formed through the cylindrical surface and is configured to receive airflow from a laundry cabinet and to direct the airflow along the cylindrical surface within the cavity. A vortex diverter extends within the cavity from the second end and is configured to interrupt airflow as it passes within the cavity between the diverter and the cylindrical surface to separate particulates from the airflow. A particulate outlet formed through the cylindrical surface and axially spaced from the air inlet is configured to direct particulates separated from the airflow toward a particulate receptacle.

### CROSS-REFERENCE TO RELATED APPLICATIONS

This application claims priority under 35 U.S.C. § 119(e) to U.S. Provisional Application 63/386,370, filed on Dec. 7, 2022. The disclosure of this prior application is considered part of the disclosure of this application and is hereby incorporated by reference in its entirety.

### TECHNICAL FIELD

This disclosure relates to a particulate separation system, and more particularly, to a particulate separation system for a laundry dryer.

### BACKGROUND

This section provides background information related to the present disclosure and is not necessarily prior art.

Laundry systems, and particularly dryers, conventionally include a cabinet within which a tumbler basket is disposed for processing laundry. Through operation of a motor driven fan, hot air is drawn from a heater into the cabinet, through the tumbler basket, through a lint screen, and then is exhausted to the outside environment.

Lint screens generally include at least one layer of fine mesh placed within the flow of air to filter out lint from the air from the dryer that passes through the lint filter. There is a balance between the mesh size of the screen and the performance of the lint screen. For example, a very fine mesh (i.e., fine openings) may become clogged easily, thereby increasing the temperature and airflow of the dryer system. Alternatively, a coarse mesh (i.e., larger openings) may allow finer grain lint particulates to pass through the filter. As such, traditional lint screens offer a tradeoff between decreasing the efficiency of the dryer and/or laundry system, and being particularly inefficient at filtering out lint particulates.

### SUMMARY

One aspect of the disclosure provides a cyclone filter. The cyclone filter includes a body including a cylindrical surface extending between a first end and a second end. The body defines a cavity of the cyclone filter. An air inlet is formed through the cylindrical surface. The air inlet is configured to receive an airflow from a laundry cabinet and to direct the airflow along the cylindrical surface within the cavity. A vortex diverter extends within the cavity from the second end of the body. The vortex diverter is configured to interrupt the airflow as it passes within the cavity between the vortex diverter and the cylindrical surface to separate particulates from the airflow. A particulate outlet is formed through the cylindrical surface and axially spaced from the air inlet. The particulate outlet is configured to direct particulates separated from the airflow toward a particulate receptacle.

Implementations of the disclosure may include one or more of the following optional features. In some implementations, a vortex inducer extends within the cavity from the first end and at least partially along the cylindrical surface of the body. The vortex inducer includes a cylindrical surface and is configured to direct airflow from the air inlet in a helical spiral between the cylindrical surface of the body and the cylindrical surface of the vortex inducer. In further implementations, the vortex diverter includes an annular surface extending from the second end of the body. The annular surface of the vortex diverter has a first outer diameter that is greater than a second outer diameter of the cylindrical surface of the vortex inducer.

In some examples, a clean air outlet is formed through the first end of the body. The clean air outlet is configured to receive clean air drawn from the cavity. In further examples, an opening of the clean air outlet is between the air inlet and the first end of the body. In some further examples, a clean air conduit extends through the clean air outlet and at least partially within the cavity. In some even further examples, the clean air conduit includes a cylindrical portion that extends through the clean air outlet and at least partially within the cavity and a curved portion that extends at an oblique angle between the cylindrical portion and an airflow source.

In some implementations, the air inlet includes a conduit that extends tangential to the cylindrical surface of the body. In some examples, the particulate outlet includes a conduit that extends tangential to the cylindrical surface of the body. Optionally, a central axis of the cyclone filter extends between the first end and the second end. The air inlet and the particulate outlet formed through the cylindrical surface are tangential relative to the central axis.

Another aspect of the present disclosure provides a laundry system. The laundry system includes a laundry cabinet configured to process laundry during operation of the laundry system. A particulate receptacle is configured to receive particulate separated from laundry during operation of the laundry system. The laundry system includes a particulate separation system that includes a body including a cylindrical surface extending between a first end and a second end. The body defines a cavity of the cyclone filter. An air inlet is formed through the cylindrical surface. The air inlet is configured to receive an airflow from the laundry cabinet. The air inlet is configured to direct the airflow along the cylindrical surface within the cavity. A vortex diverter extends within the cavity from the second end of the body. The diverter is configured to interrupt the airflow as it passes within the cavity between the diverter and the cylindrical surface to separate particulates from the airflow. A particulate outlet is formed through the cylindrical surface and axially spaced from the air inlet. The particulate outlet is configured to direct particulates separated from the airflow toward the particulate receptacle.

Implementations of the disclosure may include one or more of the following optional features. In some implementations, a vortex inducer extends within the cavity from the first end and at least partially along the cylindrical surface of the body. The vortex inducer includes a cylindrical surface and is configured to direct the airflow from the air inlet in a helical spiral between the cylindrical surface of the body and the cylindrical surface of the vortex inducer. In further implementations, the vortex diverter includes an annular surface extending from the second end of the body. The annular surface of the vortex diverter has a first outer diameter that is greater than a second outer diameter of the cylindrical surface of the vortex inducer.

In some examples, a clean air outlet is formed through the first end of the body. The clean air outlet is configured to receive clean air drawn from the cavity. In further examples, an opening of the clean air outlet is between the air inlet and the first end of the body. In some further examples, a clean air conduit extends through the clean air outlet and at least partially within the cavity. In some even further examples, the clean air conduit includes a cylindrical portion that extends through the clean air outlet and at least partially within the cavity and a curved portion that extends at an oblique angle between the cylindrical portion and an airflow source of the laundry system.

In some implementations, the air inlet includes a conduit that extends tangential to the cylindrical surface of the body. In some examples, the particulate outlet includes a conduit that extends tangential to the cylindrical surface of the body. Optionally, a central axis of the cyclone filter extends between the first end and the second end. The air inlet and the particulate outlet formed through the cylindrical surface are tangential relative to the central axis.

Yet another aspect of the disclosure provides a laundry system including a cabinet including a tumbler for processing laundry and an access port extending through the cabinet, and a particulate separation system for removing particulates from air in the tumbler. The laundry system also includes a particulate hopper for collecting the removed particulates. The particulate hopper is disposed beneath the particulate separation system and includes a cleanout port. The cleanout port cooperates with the access port of the cabinet to provide an access channel for removing the collected removed particulates from the particulate hopper.

Implementations of the disclosure may include one or more of the following optional features. In some implementations, the cabinet further includes a front side panel and a rear side panel disposed on a different side of the cabinet than the front side panel. Here, the access port extends from the front side panel to the rear side panel. In these implementations, the access port of the cabinet further includes an inlet formed in the rear side panel of the cabinet and an outlet formed in the front side panel of the cabinet. In these implementations, the particulate hopper may be external to the cabinet and the cleanout port may be adjacent to the inlet formed in the rear side panel of the cabinet. The access port may include a cleanout duct extending from a first end at the cleanout port of the particulate hopper, through the cabinet, to a second end at the outlet of the access port formed in the front side panel of the cabinet. Additionally or alternatively, the particulate hopper is affixed to the rear side panel of the cabinet.

In some examples, the particulate separation system includes a cyclonic separation system. Here, the cyclonic separation system may be external to the cabinet. In these examples, wherein the cyclonic separation system may include an array of one or more cyclone filters. For example, the array of one or more cyclone filters includes four cyclone filters.

Another aspect of the disclosure provides a laundry system including a cabinet including a tumbler for processing laundry and an access port extending through the cabinet, a control board including a user interface, and a particulate separation system for removing particulates from air in the tumbler. The laundry system also includes a particulate hopper for collecting the removed particulates. The particulate hopper includes a capacity sensor in communication with the control board and configured to detect a capacity of the particulate hopper.

This aspect may include one or more of the following optional features. In some implementations, the capacity sensor sends a signal to the control board in response to detecting the capacity of the particulate hopper has exceeded a fill threshold. For instance, the fill threshold may be configured by a user of the user interface. In some examples, the user interface of the control board includes a cleanout notification. Here, the cleanout notification is configured to alert a user that the particulate hopper is full. In some implementations, the access port extending through the cabinet includes an access control in communication with the control board and configured to allow access to the access port. In these implementations, the access control may allow access to the access port in response to receiving an indication that a user has selected a cleanout indication displayed in the user interface of the control board.

In some examples, the laundry system further includes a fan in communication with the control board and disposed between the cabinet and the particulate separation system. In these examples, the laundry system may further include a temperature sensor configured to detect a temperature of the laundry system and communicate the detected temperature to the control board. Here, the control board may increase a speed of the fan in response to determining, using a fan algorithm, that a detected temperature of the laundry system has exceeded a temperature threshold. In some implementations, the particulate separation system includes a cyclonic separation system external to the cabinet.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A-1C are perspective views of a laundry system including a particulate separation system according to the present disclosure.

FIG. 2 is a front perspective view of the laundry system of FIG. 1A.

FIG. 3 is a perspective cross-sectional view of the laundry system of FIG. 2, taken along line 3-3 of FIG. 2.

FIG. 4 is a side cross-sectional view of the laundry system of FIG. 2, taken along line 3-3 of FIG. 2.

FIG. 5 is a front perspective view of the particulate separation system of FIGS. 1A-1C.

FIG. 6 is a rear perspective view of the particulate separation system of FIGS. 1A-1C.

FIG. 7 is a partial rear perspective view of the particulate separation system of FIGS. 1A-1C.

FIG. 8 is a partial top-rear perspective view of the particulate separation system of FIGS. 1A-1C.

FIG. 9 is a partial front perspective view of the particulate system of FIGS. 1A-1C.

FIG. 10 is a perspective view of a cyclonic filter of the particulate system of FIGS. 1A-1C.

FIG. 11 is a cross-sectional view of the cyclonic filter of FIG. 10, taken along line 11-11 of FIG. 10.

FIG. 12 is a perspective view of another laundry system including a particulate separation system according to another aspect of the present disclosure.

FIG. 13 is a side elevation view of the laundry system of FIG. 12.

FIGS. 14 and 15 are front perspective views of the particulate separation system of FIG. 12.

FIG. 16 is a rear perspective view of the particulate separation system of FIG. 12.

FIG. 17 is a partial rear perspective view of the particulate separation system of FIG. 12.

FIG. 18 is a front perspective view of another laundry system including a particulate separation system according to another aspect of the present disclosure.

FIG. 19 is rear perspective view of the laundry system of FIG. 18.

FIG. 20 is a cross-sectional view of the laundry system of FIG. 18, taken along the line 20-20 of FIG. 18.

FIG. 21 is a cross-sectional view of the laundry system of FIG. 18, taken along the line 21-21 of FIG. 18.

FIG. 22 is a perspective view of the particulate separation system of the laundry system of FIG. 18.

FIG. 23 is a cross-sectional view of the particulate separation system of FIG. 22, taken along the line 23-23 of FIG. 22.

FIG. 24 is a top side view of cyclone filters and clean air conduits of the particulate separation system of FIG. 22.

FIG. 25 is a perspective view of a cyclone filter and a clean air conduit of the particulate separation system of FIG. 22.

FIG. 26 is a front elevation view of the cyclone filter of the particulate separation system of FIG. 22.

FIG. 27A is a cross-sectional perspective view of the cyclone filter and clean air conduit of the particulate separation system of FIG. 22, taken along the line 27-27 of FIG. 25.

FIG. 27B is a cross-sectional perspective view of the cyclone filter and clean air conduit of the particulate separation system of FIG. 22, taken along the line 27-27 of FIG. 25, and with the clean air conduit removed from the cyclone filter.

FIG. 27C is a cross-sectional plan view of the cyclone filter and clean air conduit of the particulate separation system of FIG. 22, taken along the line 27-27 of FIG. 25.

FIG. 28 is a perspective view of another example of a laundry system according to the principles of the present disclosure.

FIG. 29 is a perspective view of the laundry system of FIG. 28, showing an access panel of the laundry system removed to expose a particulate hopper.

FIG. 30 is a partial perspective view of the laundry system of FIG. 28, showing lower panels of the laundry system removed to expose a particulate separation system.

FIG. 31 is a side elevation view of the laundry system of FIG. 28, showing a side panel of the laundry system removed to illustrate an interior configuration.

FIG. 32 is a side perspective view of the laundry system of FIG. 28, showing a side panel of the laundry system removed to illustrate an interior configuration.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

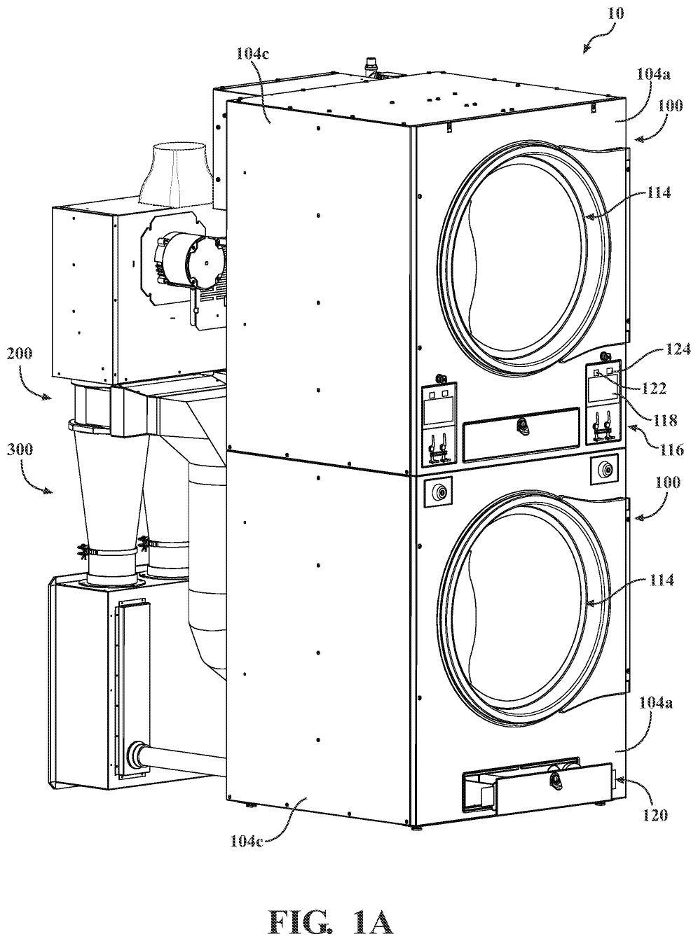

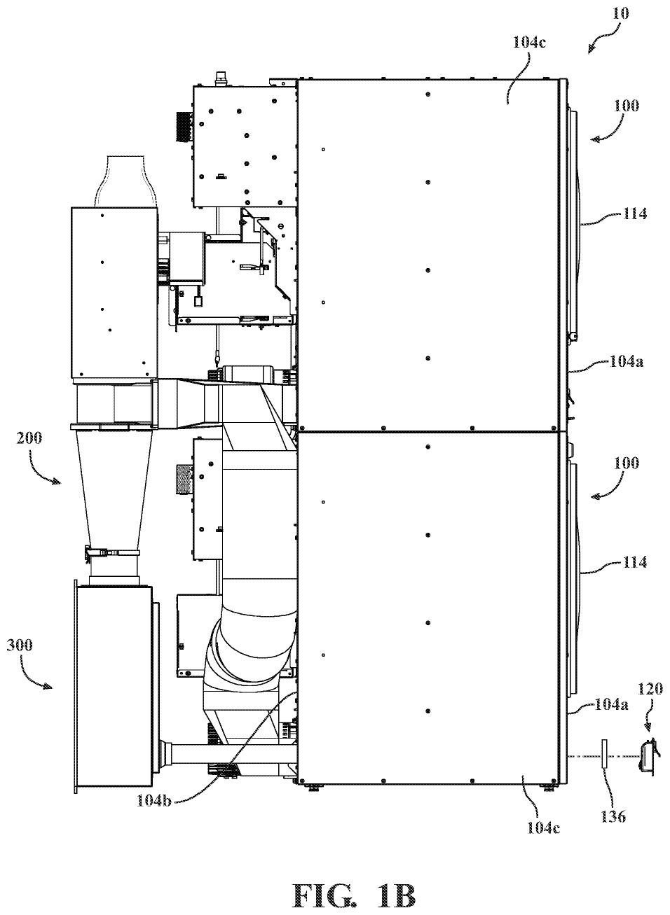

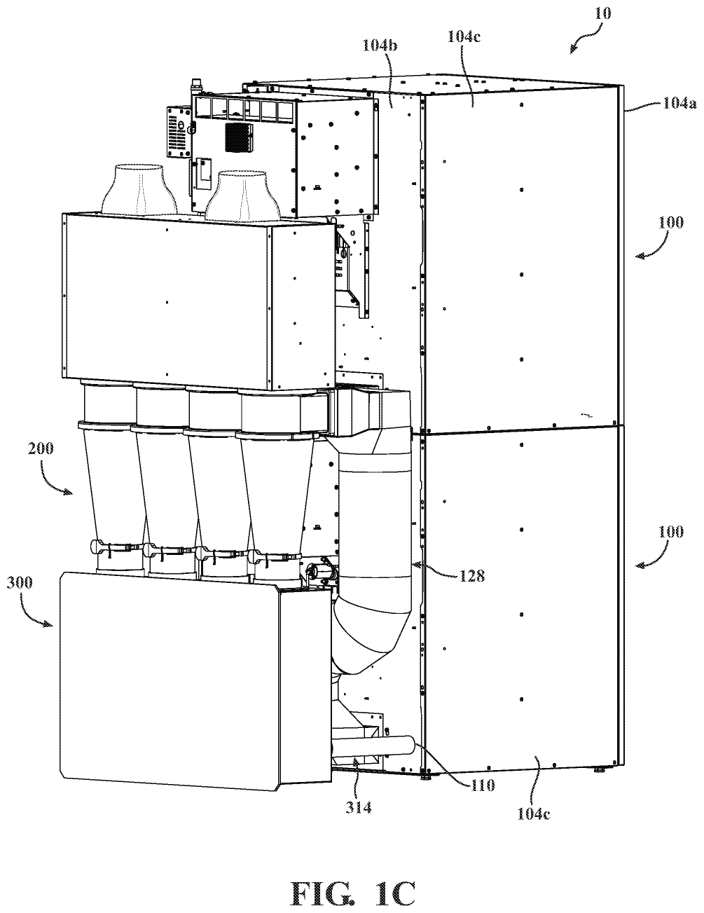

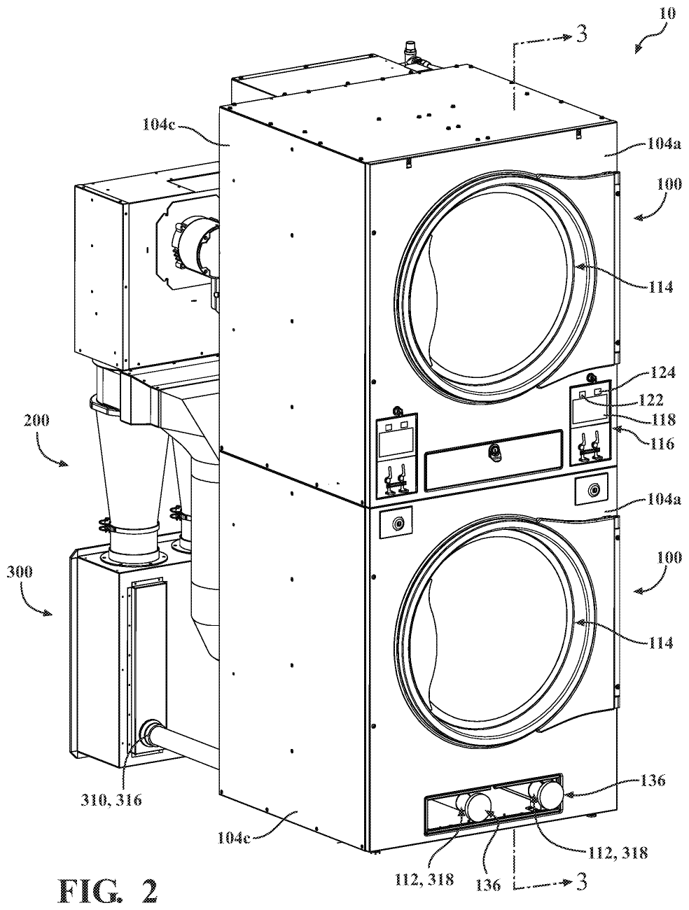

Referring to FIGS. 1A-2, a laundry system 10 is illustrated and includes a cabinet 100, a particulate separation system 200, and a particulate hopper 300. Briefly, and as described in more detail below, during operation, air 12 is drawn through the cabinet 100 as it processes laundry, through the particulate separation system 200, and to the outside environment or back into the cabinet 100. The particulate separation system 200 and the particulate hopper 300 are external to the cabinet 100, where the particulate separation system 200 removes particulates 14 from the air 12 drawn through the cabinet 100 and deposits the removed particulates 14 in the particulate hopper 300 disposed beneath the particulate separation system 200. Advantageously, the particulate hopper 300 can be emptied when full via a cleanout duct 314 that extends from the particulate hopper 300, through the cabinet 100, and to a front of the cabinet 100.

As shown, the laundry system 10 includes two (2) cabinets 100 (i.e., vertically stacked tumbler dryers) However the laundry system 10 may include any number of cabinets 100 enclosing one or more dryer pockets (e.g., tumblers). For example, the laundry system 10 may include a single cabinet enclosing a stacked pair of tumblers. In other examples, the particulate separation system 200 and particulate hopper 300 may be implemented in conjunction with a cabinet or plurality of cabinets that include a single washer, a single dryer, a single combined washer/dryer, stacked washers, stacked combined washer/dryers, or a washer stacked with a dryer. In view of the substantial similarity in structure and function of the components associated with each of the cabinets 100 of the laundry system 10, like reference numerals are used hereinafter and in the drawings to identify like components.

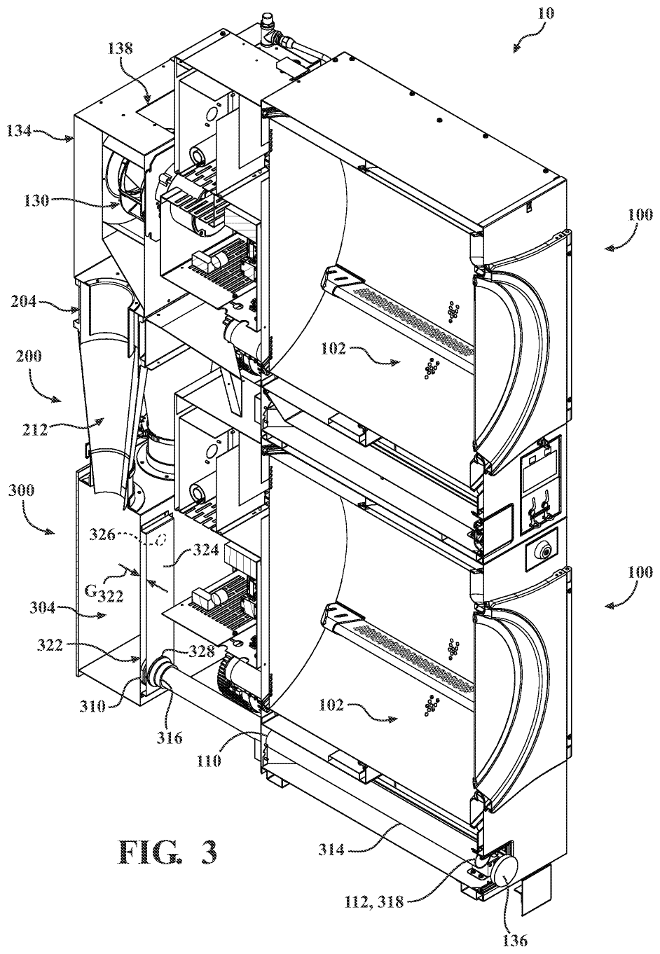

With reference to FIG. 3, the cabinet 100 includes a tumbler 102 for processing laundry and one or more side panels 104a-104d. As shown, the cabinet 100 includes a first, front side panel 104a, a second, rear side panel 104b disposed on an opposite side (i.e., a back side) of the cabinet 100 than the front side panel 104a. A third side panel 104c and a fourth side panel 104d each extend between the front side panel 104a and the rear side panel 104b such that the side panels 104a-104d collectively define a cavity 106 in which the tumbler 102 is disposed. The cabinet 100 further includes an access port 108 extending through the cabinet 100 from an inlet 110 disposed at the rear side panel 104b to an outlet 112 disposed at the front side panel 104a.

The cabinet 100 additionally includes a door 114 mounted to an opening in the front side panel 104a that allows a user to access the tumbler 102, a control board 116 including a user interface 118, and an access panel 120 in communication with the control board 116. The access panel 120 covers the outlet 112 formed in the front side panel 104a and may include a lock and/or an actuator. Here, when the particulate hopper 300 is full and needs to be emptied, the control board 116 may send a signal (e.g., in response to a user selecting a cleanout notification) to the actuator to unlock/open the access panel 120 for opening by a user. In other implementations, a user may manually unlock the access panel 120 using a manual locking or latching device.

The control board 116 includes data processing hardware 122 and memory hardware 124. The data processing hardware 122 can process instructions for execution within the control board 116, including instructions stored in the memory hardware 124 to display information in the user interface 118. In some implementations, the user interface 118 is rendered for display on a screen of the control board 116 and responds to any form of sensory feedback, such as visual feedback, auditory feedback, or tactile feedback, and input from the user can be received in any form including acoustic, speech, or tactile input. Additionally or alternatively, the user interface 118 includes one or more mechanical buttons and/or lights for a user to interact with.

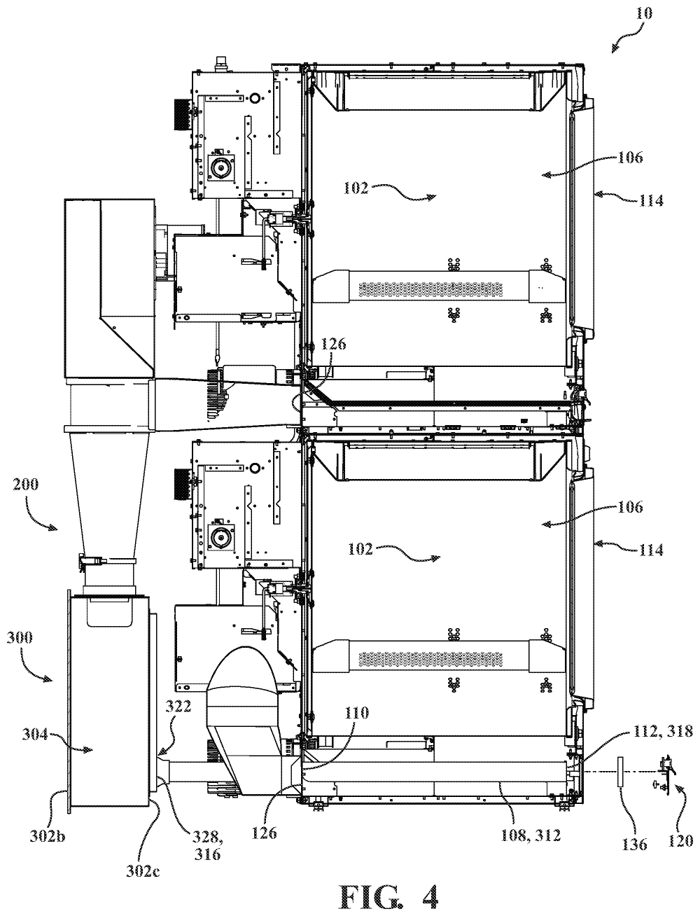

Referring to FIGS. 1B, 1C, and 4, the cabinet 100 also includes an exhaust or air outlet 126 formed in the rear side panel 104b. A tumbler exhaust duct 128 is connected to the air outlet 126 and provides a conduit or passageway for airflow between the cabinet 100 and the particulate separation system 200. In the illustrated example, an inlet of a first tumbler exhaust duct 128 is associated with the air outlet 126 of a lower one of the cabinets 100 and an inlet of a second one of the tumbler exhaust ducts 128 is associated with the air outlet of an upper one of the cabinets 100. As described above, the particulate separation system 200 and the particulate hopper 300 are remotely located from the cabinet 100 and may be located adjacent to the rear side panel 104b of the cabinet 100. In other words, the particulate separation system 200 is provided as a standalone, peripheral system from the cabinet. The particulate separation system 200 removes particulates 14 from the air 12 flowing from the cabinet 100, where the removed particulates 14 are collected by the particulate hopper 300 disposed beneath the particulate separation system 200 while clean air 12C is drawn upward. While the use of a screen to separate lint from air is well known in the art, the particulate separation system 200 may operate entirely without a screen.

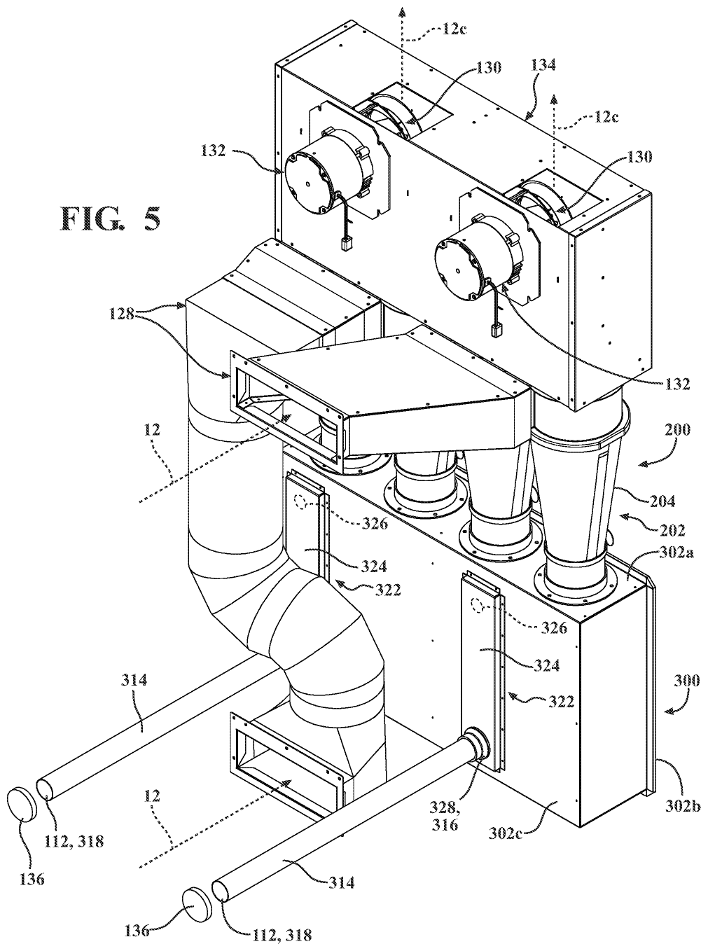

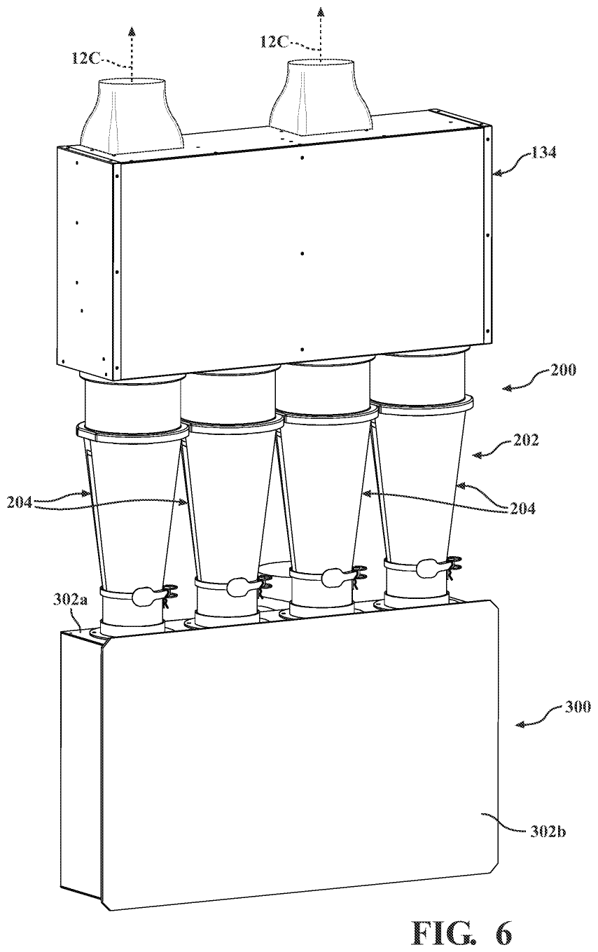

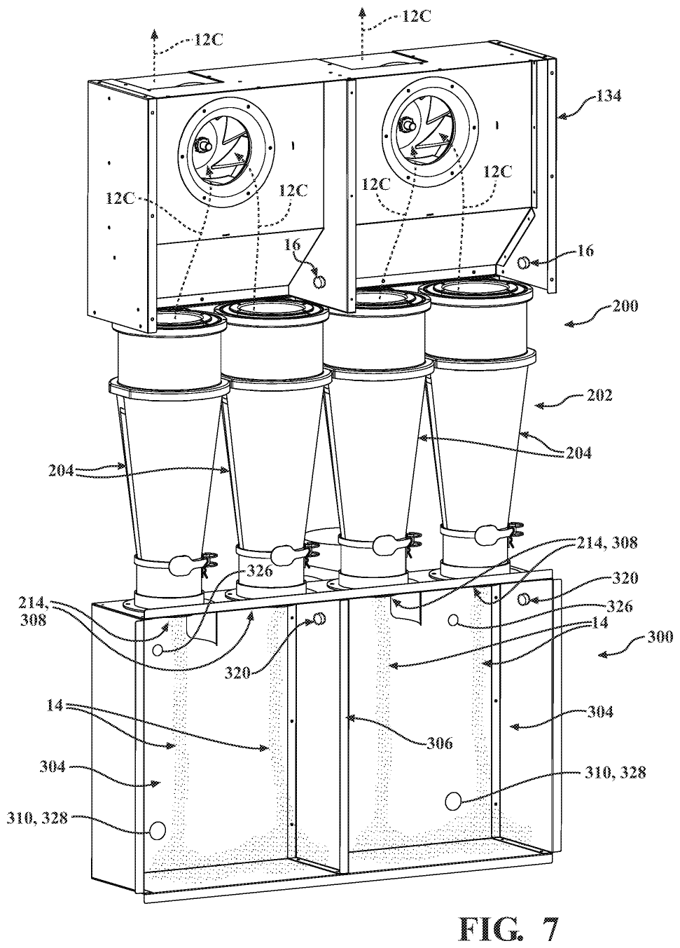

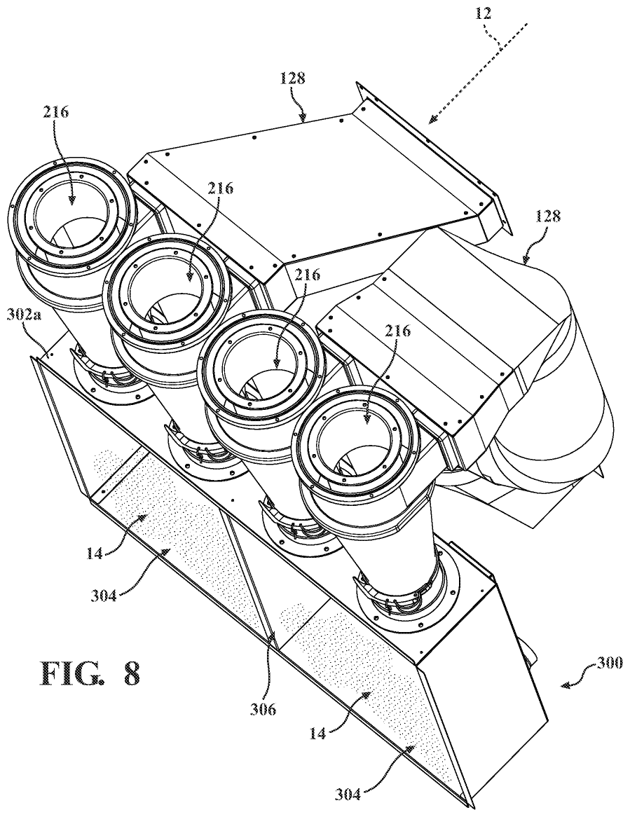

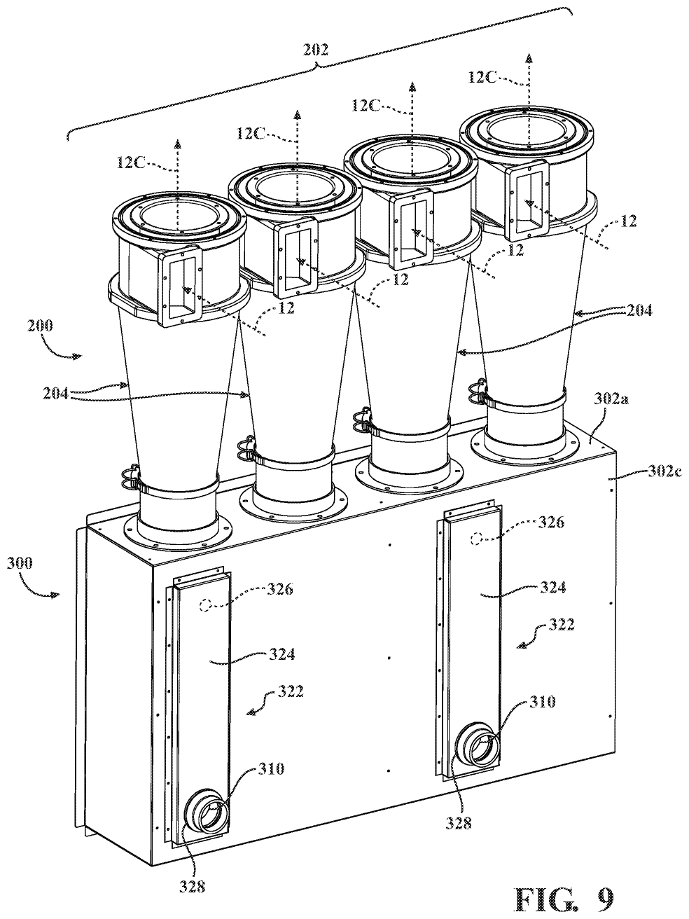

Referring to FIGS. 5-11, in some implementations, the particulate separation system 200 includes a cyclonic separation system 202 external to the cabinet 100. However, in other implementations the particulate separation system 200 may be inside the cabinet 100. The cyclonic separation system 202 may include an array of one or more cyclone filters 204 that are designed to receive incoming air 12 from the cabinet 100 (via the tumbler exhaust duct 128), and separately output particulates 14 and clean air 12C. As shown, the array of one or more cyclone filters 204 includes four cyclone filters 204. Here, each one of the cabinets 100 of the laundry system 10 is connected to an array of two of the cyclone filters 204 by one of the tumbler exhaust ducts 128, such that the tumbler exhaust duct 128 associated with each cabinet 100 is connected to a pair of the cyclone filters 204 operating in parallel. However, any combination of cabinets 100 and/or cyclone filters 204 in the array of cyclone filters 204 may be used without departing from the scope of the present disclosure. In view of the substantial similarity in structure and function of the components associated with each of the cyclone filters 204 in the cyclonic separation system 202, like reference numerals are used hereinafter and in the drawings to identify like components.

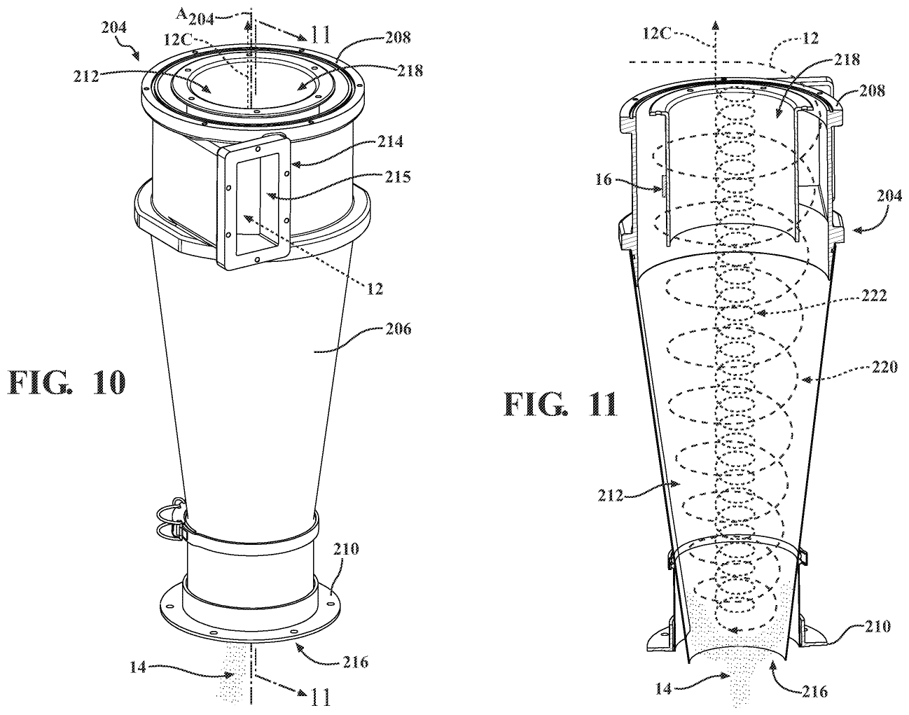

Referring to FIGS. 10 and 11, the cyclone filter 204 has a cone-shaped body 206 that tapers from a first end 208 at the top of the cyclone filter 204 to a second end 210 at the bottom of the cyclone filter 204 to define a frustoconical cyclone cavity 212 defining a central axis A₂₀₄ of the cyclone filter 204. The body 206 of the cyclone filter 204 includes an air inlet 214 that directs air 12 from the tumbler exhaust ductwork 128 into the cyclone cavity 212, a particulate outlet 216 formed at the lower second end 210 of the body 206 for the removed particulates 14 to pass through to the particulate hopper 300, and a clean air outlet 218 formed at the first end 208 of the body 206 for the clean air 12C to exit the cyclone filter 204. As shown, the air inlet 214 includes an attachment interface for connecting the cyclone filter to an outlet of one of the tumbler exhaust ducts 128. The air inlet 214 further defines an inlet conduit 215 configured to introduce the air 12 into the cyclone cavity 212 in a substantially tangential manner relative to the body 206 and the central axis A₂₀₄. Conversely, each of the particulate outlet 216 and the clean air outlet 218 are coaxial with the central axis A₂₀₄ of the filter body 206.

During operation of the laundry system 10, the air 12 from the cabinet 100 enters the cyclone filter 204 at a tangent via the air inlet 214 and begins to flow in a circular downward spiral within the cyclone cavity 212 toward the second end 210 of the body 206, creating an outer spiral vortex 220 flowing from the air inlet 214 to the particulate outlet 216 and an inner spiral vortex 222 flowing from the second end 210 of the body 206 toward the clean air outlet 218 formed at the first end 208 of the body 206. As the air 12 flows within the outer spiral vortex 220, the particulates 14, due to their mass, exit the outer spiral vortex 220 and fall through the particulate outlet 216 and into the particulate hopper 300. Once the air 12 reaches the second end 210 of the body, the flow transitions from the downward-flowing outer spiral vortex 220 to the upward-flowing inner spiral vortex 222, whereby the clean air 12C flows up through the filter body 206 along the axis A₂₀₄ to the clean air outlet 218.

Referring to FIGS. 1A, 3, 5, and 7, in some implementations a fan 130 driven by a motor 132 in communication with the control board 116 is disposed within a housing 134 that sits on top of the particulate separation system 200. Here, the fan 130 is configured to draw a flow of the air 10 through the tumbler 102 as the tumbler 102 is rotated to process the laundry, out the air outlet 126 of the cabinet 100, through the tumbler exhaust ductwork 128 to the particulate separation system 200, and finally draws the clean air 12C through the clean air outlet 216, through the fan 130, and exhausts the clean air 12C to the outside environment via an exhaust 138 or back into the tumbler 102. In some implementations, the fan 130 may be disposed between the cabinet 100 and the particulate separation system 200. In other implementations, the fan 130 is disposed within the particulate separation system 200. Alternatively, the fan 130 is disposed within the cabinet 100.

In some examples, the laundry system 10 includes one or more temperature sensors 16 configured to measure a temperature of the laundry system 10 and communicate the measured temperature to the control board 116. The control board 116 is configured to evaluate the measured temperature to detect operating conditions of the laundry system. For example, a relatively high measured temperature detected by the control board 116 may correspond to blockage in the tumbler exhaust duct 128 and/or the exhaust 138 of the laundry system 10. Here, the control board 116 may instruct the fan 130 to increase speed to clear the blockage. The one or more temperature sensors 16 may be located in any combination of the air passageways in the laundry system 10, such as the cavity 106 of the cabinet 100, the tumbler exhaust duct 128, the particulate separation system 200, and/or the housing 134 of the fan 130. Here, the control board 116 may execute (e.g., via the data processing hardware 122) a fan algorithm to optimize a variable speed of the fan 130 based on the one or more temperature readings measured by the temperature sensors 16 located in the laundry system 10. In other words, the control board 116 may increase a speed of the fan 130 in response to determining, using the fan algorithm, that the detected temperature of the laundry system 10 has exceeded a temperature threshold.

Referring now to FIGS. 4-9, the particulate hopper 300 includes one or more panels 302a-302d that define a hopper cavity 304 that collects the removed particulates 14 from the particulate separation system 200. As shown, the particulate hopper 300 includes a divider 306 that forms two particulate hopper cavities 304 that each collect particulates 14 from two of the cyclone filters 204. However, in some implementations the hopper 300 does not include the divider 306, and instead collects particulates 14 from the entire particulate separation system 200. It should be appreciated that this disclosure contemplates any numbered combination of cabinets 100, particulate separation systems 200, and particulate hoppers 300. In view of the substantial similarity in structure and function of the components associated with each of the particulate hoppers 300, like reference numerals are used hereinafter and in the drawings to identify like components.

The particulate hopper 300 may include a top panel 302a including a particulate inlet 308 that aligns with the particulate outlet 216 of the particulate separation system 200 and allows the separated particulates 14 to fall into the hopper cavity 304. Additionally, the particulate hopper 300 includes a removable service panel 302b on the rear of the particulate hopper 300, and an access panel 302c disposed on an opposite side of the particulate hopper 300 than the service panel 302b. The access panel 302c includes a cleanout port 310 that cooperates with the access port 108 formed in the cabinet 100 to provide an access channel 312 for removing the collected removed particulates 14 from the particulate hopper 300. As shown in FIGS. 2-4, the cleanout port 310 is adjacent to, and aligned with, the inlet 110 of the access port 108 of the cabinet 100.

In some implementations, the access channel 312 includes a cleanout duct 314 that extends from a first end 316 disposed on the cleanout port 308 (i.e., external to the dryer), through the cabinet 100, to a second end 318 at the outlet 112 of the access port 108 formed in the front side panel 104a of the cabinet 100. In these implementations, the access channel 312 may affix the particulate hopper 300 to the rear side panel 104b of the cabinet 100. When the particulate hopper 300 is full of particulates 14, a user may empty the particulate hopper 300 by sucking the particulates 14 out via a vacuum connected to the second end 318 of the cleanout duct 314 disposed at the front side panel 104a of the cabinet 100.

As shown in FIGS. 3-5, 7, and 9, the particulate hopper 300 includes a low-clog system 322 to allow the cleanout process to be fast and effective with minimal to no clogging of the cleanout duct 314. The low-clog system 322 may be affixed to the access panel 302c and include a panel 324 shaped to form an air gap G₃₂₂ (FIG. 3) between the access panel 302c and the panel 324. The panel 324 includes a low-clog port 328 formed in the face of the panel 324, which is aligned with the cleanout port 310 formed in the access panel 302c and the first end 316 of the cleanout duct 314. In other words, the low-clog port 328 is disposed between and fluidly connects the cleanout port 310 and the first end 316 of the cleanout duct 314. The low-clog system 322 additionally includes a bypass aperture 326 formed in the access panel 302c at a position that is spaced apart from the cleanout port 310. In the illustrated example, the bypass aperture 326 is disposed above and vertically aligned with the cleanout port 310. During the cleanout process, at the same time that the vacuum draws particulates 14 through the low-clog port 328, clean air is drawn through the bypass aperture 326 in the access panel 302c, into the air gap G₃₂₂ formed between the access panel 302c and the panel 324, and mixes with the particulates 14 entering the cleanout duct 314 at the first end 316. By mixing the flow of clean air drawn in via the bypass aperture 326 with the particulates 14, clogs in the cleanout duct 314 are effectively eliminated by ensuring that a constant flow of air can be maintained through the cleanout duct 314 via the bypass aperture 326. For example, in instances where particulates 14 may collect within the cleanout port 310 and cause the flow of air through the cleanout duct 314 to become static, a secondary flow of air is drawn through the bypass aperture 326 to disrupt the collection of particulates 14 and provide a dynamic flow of air into the first end 316 of the cleanout duct 314.

The particulate hopper 300 further includes a capacity sensor 320 in communication with the control board 116 and configured to measure a capacity of the hopper cavity 304 of the particulate hopper 300. The capacity sensor 320 measures the capacity of the hopper cavity 304 and sends a signal to the control board 116, which in response to determining the capacity of the particulate hopper 304 has exceeded a fill threshold, sends a signal indicating that the particulate hopper 304 needs to be emptied. Here, the fill threshold may be configured by a user of the user interface 118. For example, a user may select a capacity that is an acceptable threshold for the particulate hopper 300, where the control board 116 generates a notification (e.g., warning light, alarm) in response to detecting the capacity of the particulate hopper 304 has exceeded the fill threshold configured by the user. In other examples, the fill threshold is configured by the manufacturer of the laundry system 10 (e.g., on a regular schedule to ensure maximum performance).

In some implementations, the user interface 118 of the control board 116 includes a cleanout notification configured to alert a user that the particulate hopper 300 is full (i.e., needs to be emptied). For example, the cleanout notification may correspond to a graphical element displayed in the user interface 118. In other examples, the cleanout notification may correspond to a light that changes colors based on a state of the particulate hopper 300. Here, the cleanout notification light may switch from a first color (e.g., green) to a second, different color (e.g., orange) to notify the user that the particulate hopper 300 is full and needs to be emptied. Additionally, the control board 116 may track the schedule/frequency that the cleanout notification is generated relative to the number of cycles of the laundry system 10. Here, the control board 116 may communicate the cleanout frequency to a processing platform in communication with the control board 116 via a network to optimize the process of generating the cleanout notifications.

In some examples, the user accesses the cleanout duct 314 by removing the access panel 120 on the front of the cabinet 100 to reveal the access port 108, and can affix a vacuum to the outlet 112 of the access port 108 to vacuum the particulates 14 from the particulate hopper 300 disposed behind the cabinet 100, through the cabinet 100 via the cleanout duct 314, and out the outlet 112. By affixing a vacuum directly to/in the outlet 112, the cleanout process may be substantially dustless. In other examples, the access port 108 includes an access control 136 in communication with the control board 116 and configured to allow access to the access port 108. As shown in FIGS. 1B, 2, and 3-5, the access control 136 may be a cap that closes the outlet 112 of the access port 108. Here, the control board 116 may send a signal to an actuator of the access control 136 in response to receiving an indication that the user has addressed a cleanout indication displayed on the user interface 118 of the control board 116. Upon receiving the signal from the control board 116, the actuator may retract or remove the access control 136 to allow the user to access the cleanout duct 314. In other examples, the laundry system 10 includes a tool (e.g., screw driver, Allen wrench, or the like) to open the access control 136 for access to the cleanout duct 314.

Advantageously, the particulate separation system 200 and the particulate hopper 300 of the laundry system 10 may be retrofit to existing cabinets 100 that may or may not use a lint screen. This retrofit improves particulate separation over the traditional lint screens significantly (i.e., at least 35% increase in particulate separation). Because the particulate separation system 200 and the particulate hopper 300 are connected to the rear panel 104b of the cabinet 100, retrofitting requires minimal changes to the customer-facing portion of the cabinet 100. Moreover, the volume of the three-dimensional particulate hopper 300 is significantly larger than that of traditional lint screens (i.e., a single panel), thereby decreasing the frequency that a user may need to clean the particulates from the laundry system 10. Additionally, the modularity of the particulate separation system 200 lends the laundry system 10 to be easily replicated across multiple cabinets. For example, the laundry system 10 may be implemented in commercial applications using multiple stacked cabinets using a single particulate separation system 200 with an array of one or more cyclones and/or multiple hoppers 300, or in a residential application with a single particulate separation system 200 as described herein.

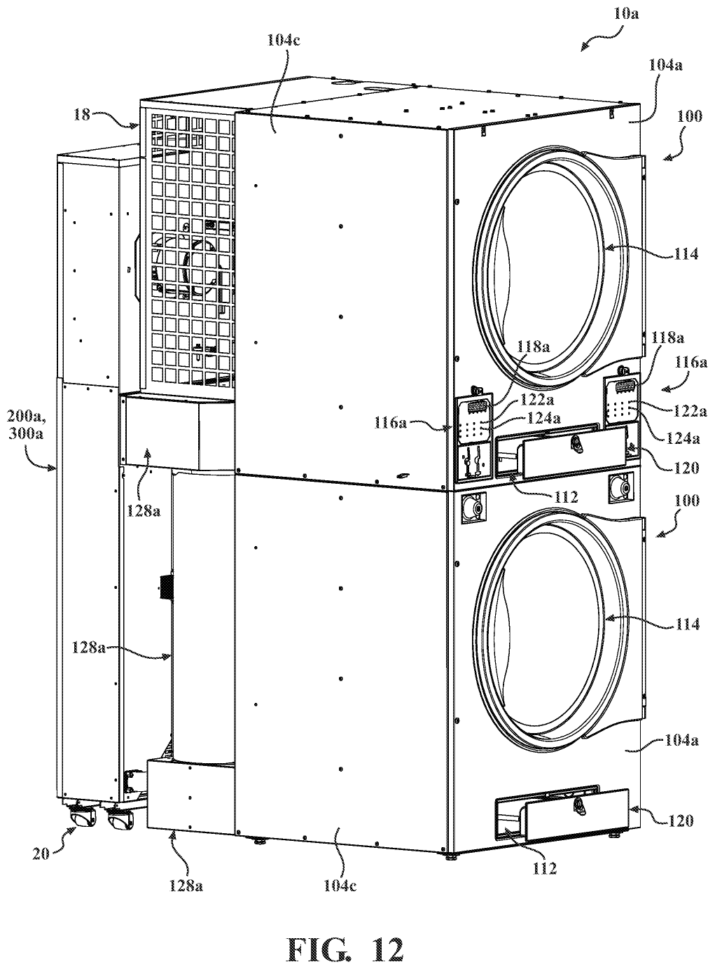

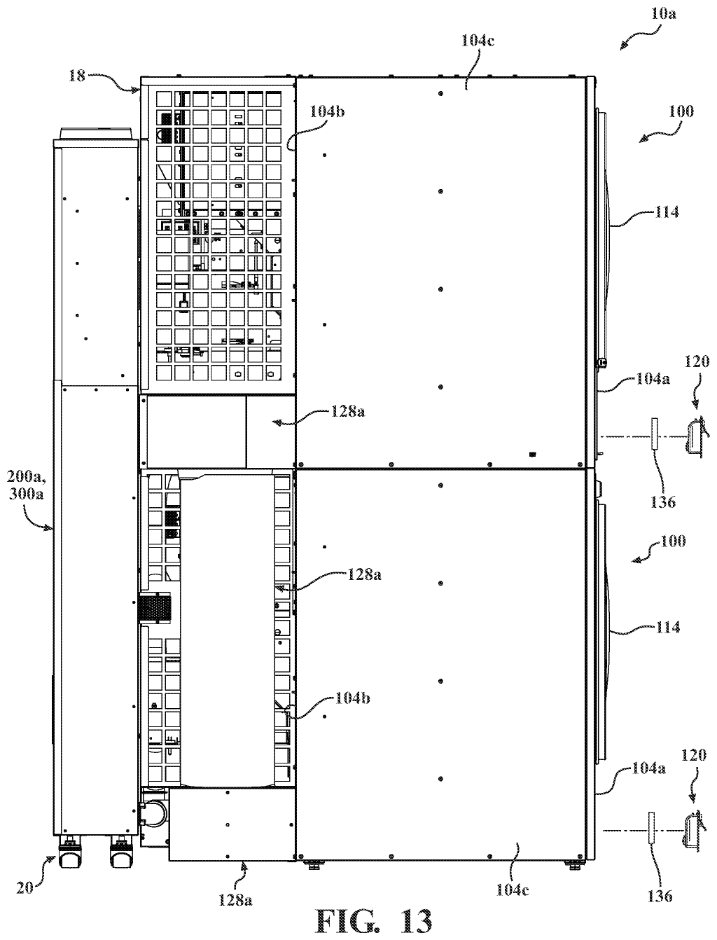

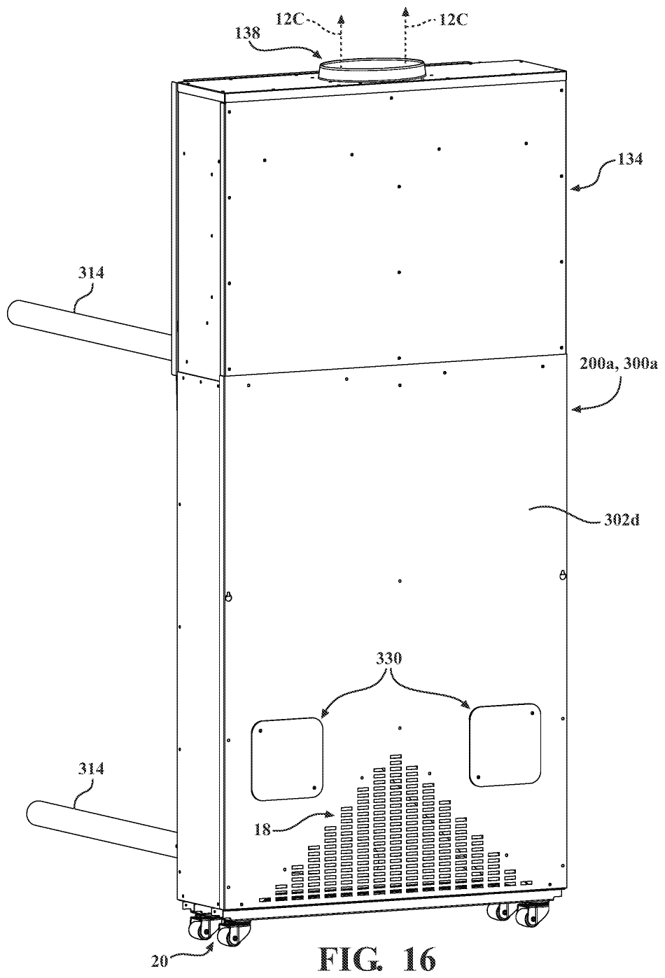

Referring to FIGS. 12-17, a laundry system 10a is provided and includes a cabinet 100, a particulate hopper 300a, and a particulate separation system 200a disposed within the particulate hopper 300a. As will be described in more detail below, by incorporating the particulate separation system 200a within the particulate hopper 300a, the particulate separation system 200a is insulated from ambient air and the amount of moisture in the laundry system 10a is reduced. In view of the substantial similarity in structure and function of the components associated with the laundry system 10 with respect to the laundry system 10a, like reference numerals containing letter extensions are used to identify those components that have been modified.

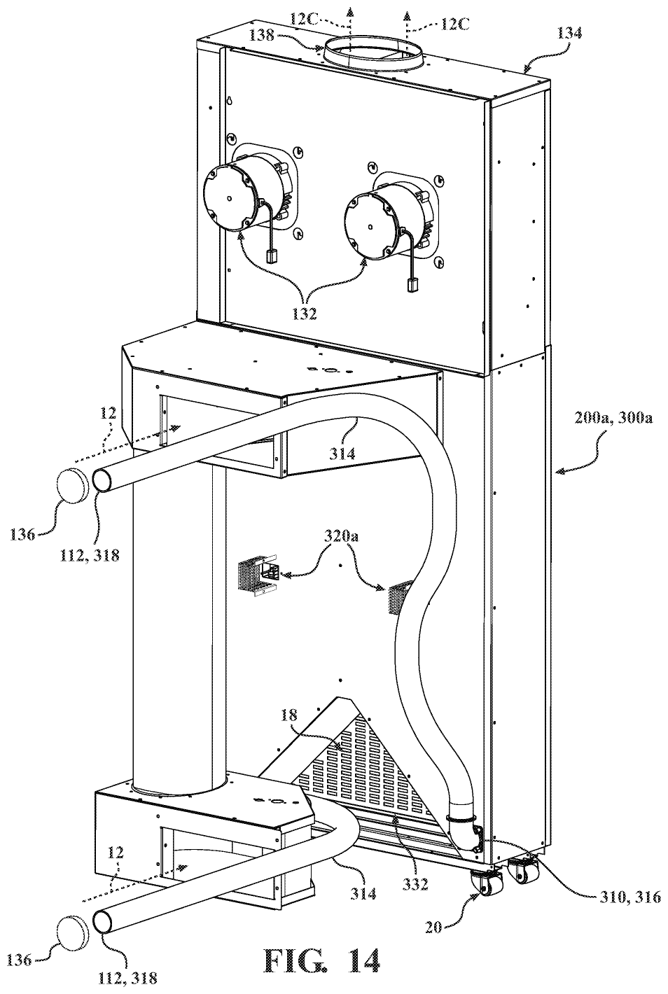

As shown in FIGS. 12 and 13, the laundry system 10a includes two (2) cabinets 100 (i.e., vertically stacked tumbler dryers). As shown, each cabinet 100 includes a first, front side panel 104a, a second, rear side panel 104b disposed on an opposite side (i.e., a back side) of the cabinet 100 than the front side panel 104a. A third side panel 104c and a fourth side panel 104d each extend between the front side panel 104a and the rear side panel 104b such that the side panels 104a-104d collectively define a cavity in which the tumbler is disposed. In addition to a door 114 mounted to an opening in the front side panel 104a, the cabinet 100 includes a control board 116a including a user interface 118a and an access panel 120 in communication with the control board 116a. The access panel 120 covers an outlet 112 formed in the front side panel 104a and may include a lock and/or an actuator. Here, when the particulate hopper 300a is full and needs to be emptied, the control board 116a may send a signal (e.g., in response to a user selecting a cleanout notification) to the actuator to unlock/open the access panel 120 for opening by a user. In other implementations, a user may manually unlock the access panel 120 using a manual locking or latching device.

In this example, the user interface 118a of the control board 116a includes a graphical user interface as well as mechanical buttons for a user of the laundry system 10a to interact with. The control board 116a includes data processing hardware 122a and memory hardware 124a. The data processing hardware 122a can process instructions for execution within the control board 116a, including instructions stored in the memory hardware 124a to display information in the graphical user interface of the user interface 118a. In some implementations, the user interface 118a is rendered for display on a screen of graphical user interface of the control board 116a and responds to any form of sensory feedback, e.g., visual feedback, auditory feedback, or tactile feedback, and input from the user can be received in any form including acoustic, speech, or tactile input. Additionally, the user interface 118a includes one or more mechanical buttons and/or lights for a user to interact with.

As shown in FIGS. 12-15, the laundry system 10a includes one or more grills 18 that enclose the additional components of the laundry system 10a and allow ambient external air to flow into stoves disposed between the particulate hopper 300a and the cabinet 100. The laundry system 10a further includes a carriage 20 that supports the particulate hopper 300a and the particulate separation system 200a. The carriage 20 allows a user of the particulate hopper 300a and the particulate separation system 200a to roll away the particulate hopper 300a and the separation system 200a to provide easy access to the stoves of the laundry system 10a for maintenance. As shown, the carriage 20 includes casters, though the carriage 20 may include any type of system that allows the particulate hopper 300a and the particulate separation system 200a to be easily moved.

Referring to FIGS. 12-14, the laundry system 10a includes a tumbler exhaust duct 128a connecting the cabinet 100 to the particulate hopper 300a and the particulate separation system 200a. As described above, the particulate hopper 300a and the particulate separation system 200a are remotely located from the cabinet 100 and may be located adjacent to the rear side panel 104b of the cabinet 100. In other words, the particulate hopper 300a and the particulate separation system 200a are provided as a standalone, peripheral system from the cabinet 100. In some implementations, one or both of the particulate hopper 300a and the particulate separation system 200 may be disposed within or integrated with the cabinet 100 to form a single unit.

The particulate separation system 200a removes particulates 14 from the air 12 flowing from the cabinet 100, where the removed particulates 14 are collected by the particulate hopper 300a disposed beneath the particulate separation system 200 while clean air 12C is drawn upward. Like the particulate separation system 200, the particulate separation system 200a may operate entirely without a screen.

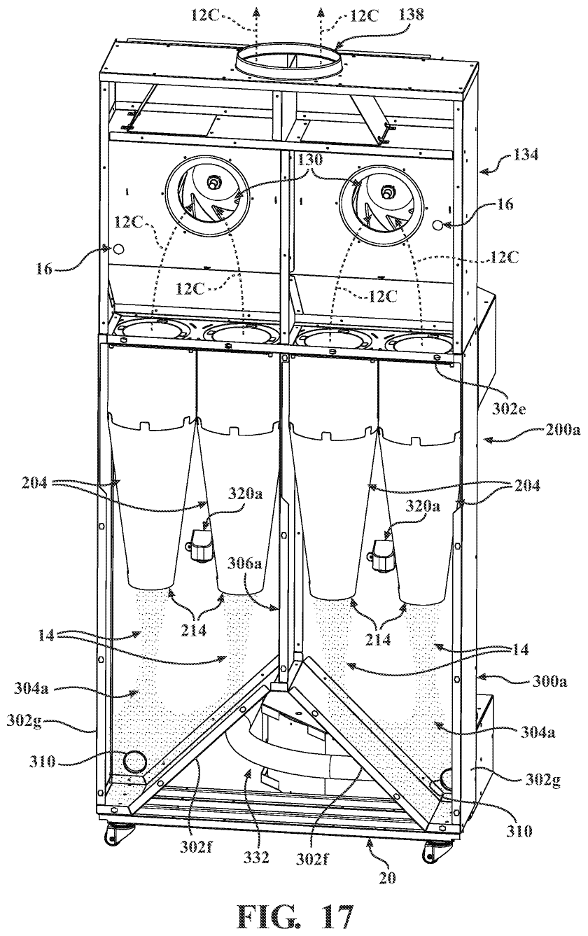

As best shown in FIG. 17, the particulate separation system 200a is mounted within the particulate hopper 300a to limit the effect of outside ambient air on the particulate system 200a. In other words, incorporating the particulate separation system 200a within the particulate hopper 300a insulates the particulate separation system 200a from ambient air, which, in turn, reduces the amount of moisture within the particulate separation system 200a and the particulate hopper 300a. For instance, cyclone filters 204 of the particulate separation system 200a are surrounded by a volume of relatively warm air contained within the particulate hopper 300a such that the cyclone filters 204 themselves are maintained at a warmer temperature than if the cyclone filters 204 are exposed to ambient air. By maintaining the cyclone filters 204 at the warmer temperature, the relatively moist air passing through the cyclone filters 204 is less likely to condense on the walls of the cyclone filter 204, thereby minimizing the introduction of moisture into the particulates 14.

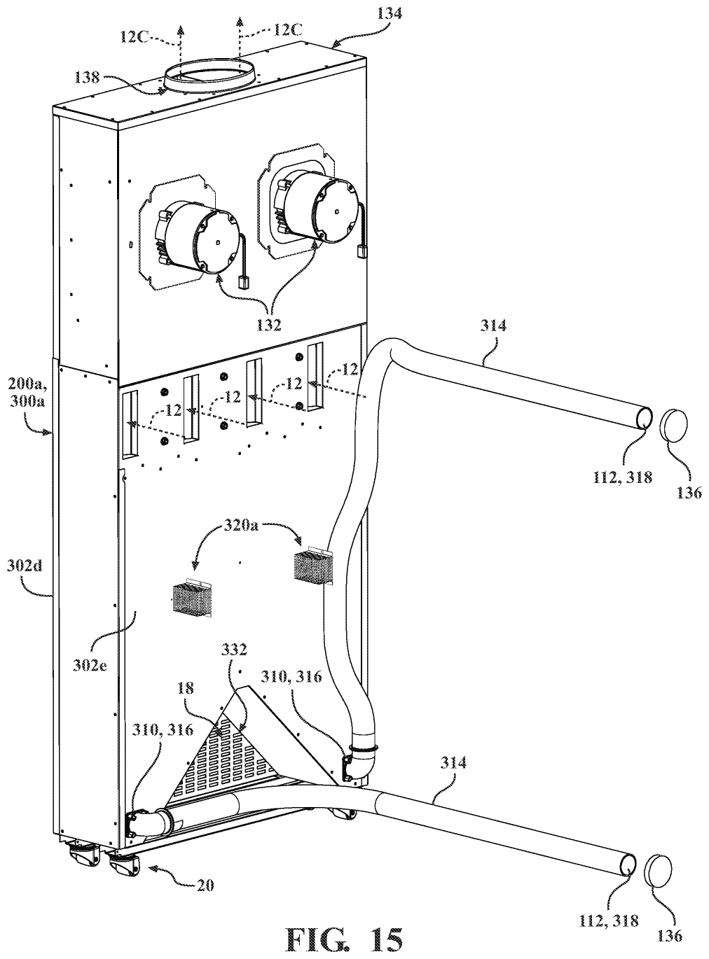

Referring now to FIGS. 15-17, the particulate hopper 300a includes one or more panels 302d-e that define a hopper cavity 304a that collects the removed particulates 12 from the particulate separation system 200a. As shown, the particulate hopper 300a includes a divider 306a that forms two particulate hopper cavities 304a that each collect particulates 14 from two of the cyclone filters 204 of the particulate separation system 200a. However, in some implementations the hopper 300a does not include the divider 306a, and instead defines a common bin that collects particulates 14 from the entire particulate separation system 200a. It should be appreciated that this disclosure contemplates any number of combination of cabinets 100, particulate separation systems 200a, and particulate hoppers 300a. In view of the substantial similarity in structure and function of the components associated with each of the particulate hoppers 300a, like reference numerals are used hereinafter and in the drawings to identify like components.

The particulate hopper 300a may include a rear panel 302d including removable service panels 330, and an access panel 302e disposed on an opposite side of the particulate hopper 300a than the rear panel 302d. The access panel 302e includes a cleanout port 310 that cooperates with the access port 108 formed in the cabinet 100 to provide an access channel 312 for removing the collected removed particulates 14 from the particulate hopper 300.

With continued reference to FIG. 17, the particulate hopper 300a further includes a pair of slanted bottom panels 302f that facilitate the flow of particulates 14 toward the cleanout port 310 of the particulate hopper 300a. Here, each of the respective particulate hopper cavities 304a includes one of the bottom panels 302f that extends at an oblique angle from a first end attached to the divider 306a to a second end adjacent to the cleanout port 310. In other words, the bottom panels 302f each converge with a respective outer wall 302g along a downward direction, whereby a cross-sectional area each of the particulate hopper cavities 304a progressively decreases or tapers in a flow direction towards the cleanout port 310. In addition to funneling the particulate towards the cleanout ports 310 to improve cleanout, the tapered configuration advantageously provides an increased airflow velocity in a direction towards the cleanout ports, thereby minimizing the likelihood of particulate clogs occurring adjacent to or within the cleanout ports 310.

As shown in FIG. 17, the slanted bottom panels 302f of each of the respective particulate hopper cavities 304a cooperate to form an intake conduit 332 extending from the rear panel 302d to the front panel 302c between the particulate hopper cavities 304a, thereby increasing airflow to the air intake of the laundry system 10a. Additionally, the particulate hopper 300a includes a top panel 302e that the particulate separation system 200a is mounted to. As shown, the housing 134 of the fan 130 is disposed on top of, and supported by the top panel 302g of the particulate hopper 300a.

Like the laundry system 10, the cleanout duct 314 of the laundry system 10a extends from a first end 316 disposed on the cleanout port 310 (i.e., external to the dryer), through the cabinet 100, to a second end 318 at the outlet 112 of the access port 108 formed in the front side panel 104a of the cabinet 100. In these implementations, the access channel 312 may connect the particulate hopper 300a to the rear side panel 104b of the cabinet 100. When the particulate hopper 300a is full of particulates 14, a user may empty the particulate hopper 300a by sucking the particulates 14 out via a vacuum connected to the second end 318 of the cleanout duct 314 disposed at the front side panel 104a of the cabinet 100.

The particulate hopper 300a further includes one or more capacity sensors 320a in communication with the control board 116a and configured to measure a capacity of the hopper cavity 304a of the particulate hopper 300a. As shown, a capacity sensor 320a is mounted on a respective access panel 302e of each hopper cavity 304a. Each capacity sensor 320a measures the available capacity of the hopper cavity 304a and sends a signal to the control board 116a, which in response to determining the capacity of the particulate hopper 304a has exceeded a fill threshold, sends a signal indicating that the particulate hopper 304a needs to be emptied. Here, the fill threshold may be configured by a user of the user interface 118a. For example, a user may select a capacity that is an acceptable threshold for the particulate hopper 300a, where the control board 116a generates a notification (e.g., warning light, alarm) in response to detecting the capacity of the particulate hopper 304a has exceeded the fill threshold configured by the user. In other examples, the fill threshold is configured by the manufacturer of the laundry system 10a (e.g., on a regular schedule to ensure maximum performance).

In some implementations, the user interface 118a of the control board 116a includes a cleanout notification configured to alert a user that the particulate hopper 300a is full (i.e., needs to be emptied). For example, the cleanout notification may correspond to a graphical element displayed in the user interface 118a. In other examples, the cleanout notification may correspond to a light that changes colors based on a state of the particulate hopper 300a. Here, the cleanout notification light may switch from a first color (e.g., green) to a second, different color (e.g., orange) to notify the user that the particulate hopper 300a is full and needs to be emptied. Additionally, the control board 116a may track the schedule/frequency that the cleanout notification is generated relative to the number of cycles of the laundry system 10a. Here, the control board 116a may communicate the cleanout frequency to a processing platform in communication with the control board 116a via a network to optimize the process of generating the cleanout notifications.

In some examples, the user accesses the cleanout duct 314 by removing the access panel 120 on the front of the cabinet 100 to reveal the access port 108, and can affix a vacuum to the outlet 112 of the access port 108 to vacuum the particulates 14 from the particulate hopper 300a disposed behind the cabinet 100, through the cabinet 100 via the cleanout duct 314, and out the outlet 112. By affixing a vacuum directly to/in the outlet 112, the cleanout process may be substantially dustless. In other examples, the access port 108 includes an access control 136 in communication with the control board 116 and configured to allow access to the access port 108. As shown in FIGS. 13-15, the access control 136 may be a cap that closes the outlet 112 of the access port 108. Here, the control board 116a may send a signal to an actuator of the access control 136 in response to receiving an indication that the user has addressed a cleanout indication displayed on the user interface 118a of the control board 116a. Upon receiving the signal from the control board 116a, the actuator may retract or remove the access control 136a to allow the user to access the cleanout duct 314. In other examples, the laundry system 10a includes a tool (e.g., screw driver, Allen wrench, or the like) to open the access control 136 for access to the cleanout duct 314.

Referring to FIGS. 14, 15, and 17, the laundry system 10a includes one or more temperature sensors 16 configured to measure a temperature of the laundry system 10a and communicate the measured temperature to the control board 116a. The control board 116a is configured to evaluate the measured temperature to detect operating conditions of the laundry system 10a. For example, a relatively high measured temperature detected by the control board 116a may correspond to blockage in the exhaust of the laundry system 10a. Here, the control board 116a may instruct the fan 130 to increase speed clear the blockage. The one or more temperature sensors 16 may be located in any combination of the air passageways in the laundry system 10, such as the cavity 106 of the cabinet 100, the tumbler exhaust 128, the particulate hopper 300a, and/or the housing 134 of the fan 130. Here, the control board 116a may execute (e.g., via the data processing hardware 122a) a fan algorithm to optimize a variable speed of the fan 130 based on the one or more temperature readings measured by the temperature sensors 16 located in the laundry system 10a. In other words, the control board 116a may increase a speed of the fan 130 in response to determining, using the fan algorithm, that the detected temperature of the laundry system 10a has exceeded a temperature threshold.

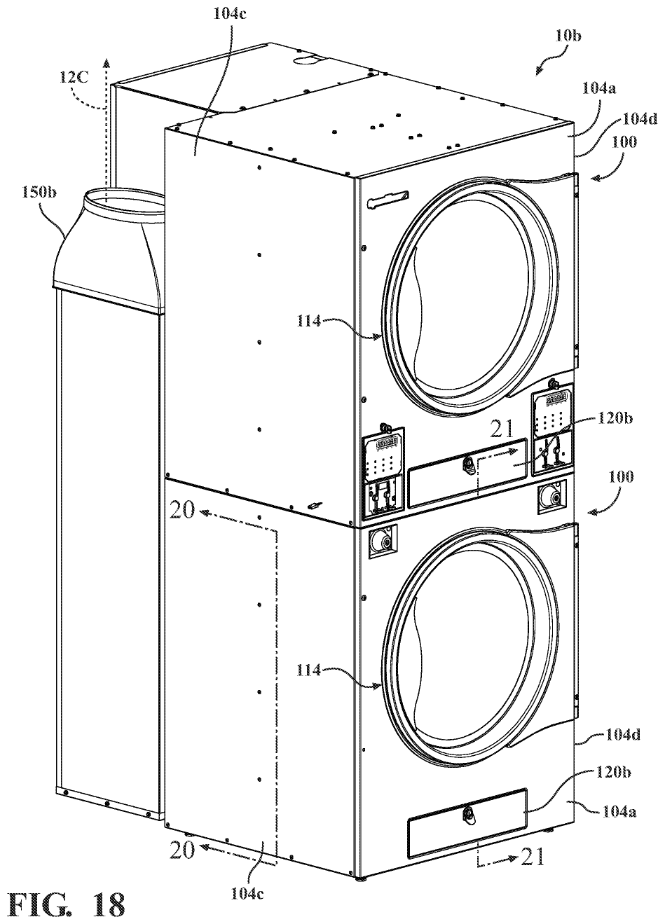

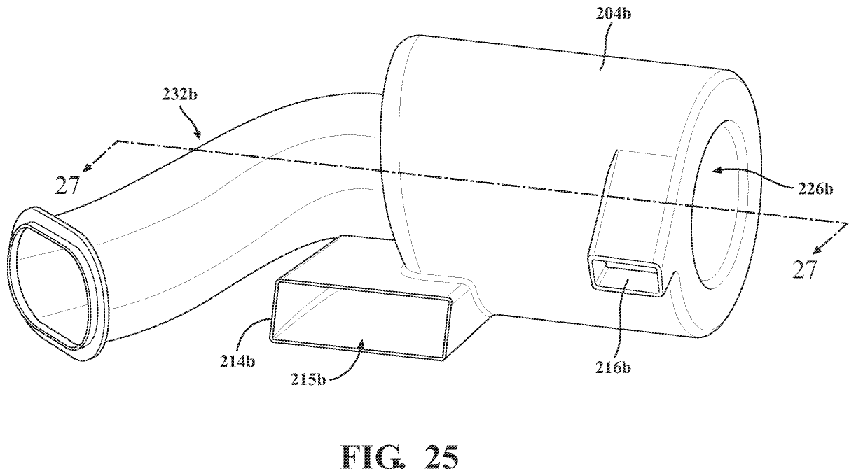

Referring to FIGS. 18-27C, a laundry system 10b is provided and includes a cabinet 100 and a particulate separation system 200b that separates particulates 14 (such as lint, hair, and other debris) from air 12 drawn through the cabinet 100 and deposits the particulates 14 into a receptacle or particulate hopper 300b at a lower portion or region of the cabinet 100 while clean air 12C separated from the particulates 14 is exhausted from the laundry system and/or drawn back through the cabinet 100. As discussed further below, the separation system 200b includes one or more horizontal cyclone filters 204b disposed at the lower portion or region of the cabinet 100 (e.g., beneath a tumbler 102) to reduce the footprint of the laundry system 10b and maintain a high rate of particulate extraction with low airflow restriction. Further, the separation system 200 deposits the particulates 14 at the particulate hopper 300b at the lower portion or region of the cabinet 100 and accessible to the user at the front of the cabinet for easier removal of the accumulated particulate 14 from the particulate hopper 300b and easier cleaning of the particulate hopper 300b. Some aspects of the laundry system 10b may be substantially similar to aspects of the laundry system 10 and the laundry system 10a described herein, such that like reference numerals are used hereinafter and in the drawings to identify like components.

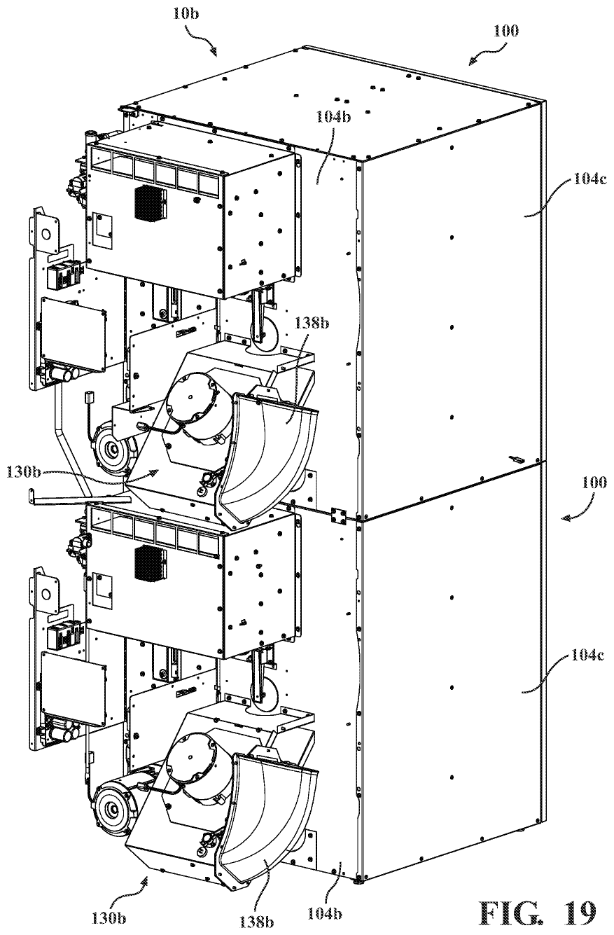

As shown in FIGS. 18 and 19, the laundry system 10b includes two (2) cabinets 100 (i.e., vertically stacked tumbler dryers). As shown, each cabinet 100 includes a first, front side panel 104a, a second, rear side panel 104b disposed on an opposite side (i.e., a back side) of the cabinet 100 than the front side panel 104a. A third side panel 104c and a fourth side panel 104d each extend between the front side panel 104a and the rear side panel 104b such that the side panels 104a-104d collectively define a cavity in which the tumbler 102 is disposed. A door 114 is mounted to an opening in the front side panel 104a to provide access to the tumbler 102 for the user. Further, an access panel 120b is disposed at an opening in the front side panel 104a below the door 114 and is removable from or movable relative to the cabinet 100 to provide access for the user to the particulate hopper 300b disposed behind the front side panel 104a and below the tumbler 102. The access panel 120b may include a lock and/or an actuator for selectively granting access to the particulate hopper 300b to the user.

The laundry system 10b also includes an exhaust or air outlet 138b formed in the rear side panel 104b, with ductwork connected to the system exhaust 138b and providing a conduit or passageway for airflow from the cabinet 100 and away from the laundry system 10b, such as via an exhaust plenum 150 fluidly connecting the system exhausts 138b to the environment. In particular, the separation system 200b is fluidly connected between the cabinet 100b and the system exhaust 138b so that particulates 14 are removed from the air 12 by the separation system 200b prior to (i.e., upstream of) the system exhaust 138b exhausting clean air 12C from the laundry system 10b. For example, a fan 130b is disposed behind the rear side panel 104b of the cabinet 100 and draws air 12 from within the cabinet 100 toward the separation system 200b and the exhausting plenum 150.

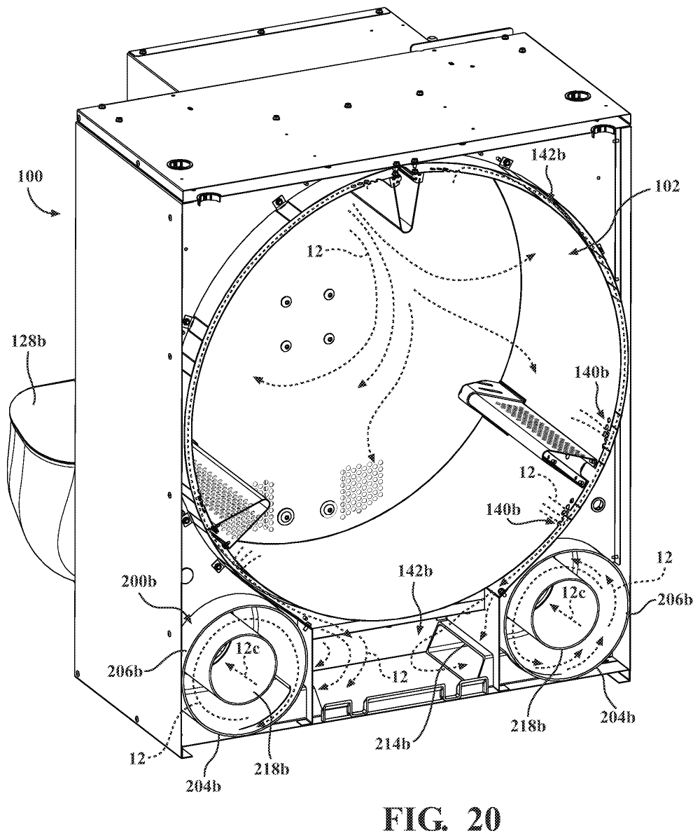

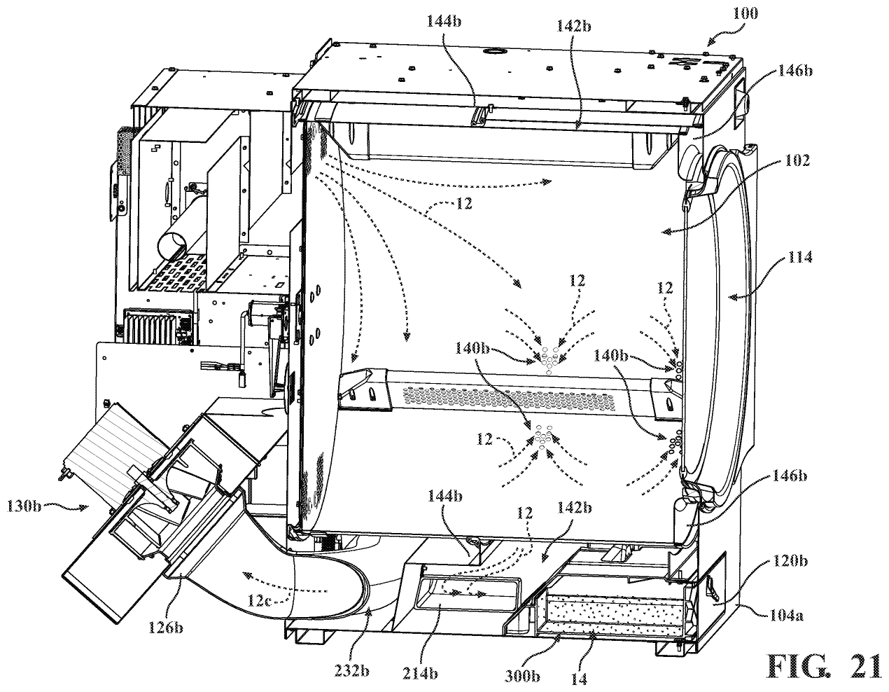

As shown in FIGS. 20 and 21, during operation of the laundry system 10b, air 12 is drawn through the cabinet 100 and into the tumbler 102. As the laundry system 10b processes laundry, particulates 14 such as lint, hair, dust, and other debris are carried with the air 12 out of the tumbler 102 and toward the separation system 200b and the air outlet 126b. For example, a series of apertures or through holes 140b are formed through the outer wall of the tumbler 102 and the apertures 140b fluidly connect the interior of the tumbler 102 with a portion of the interior of the cabinet 100 in fluid communication with the separation system 200b. The apertures 140b are configured to allow passage of air 12 and particulates 14 from the tumbler 102 toward the separation system 200b without allowing passage of laundry or larger debris from the tumbler 102.

In the illustrated example, an air conduit or cavity 142b is disposed around or encircles at least a portion of the tumbler 102, such as a forward portion of the tumbler 102 toward the door 114, so that the tumbler 102 rotates or spins within the air cavity 142b. A first seal 144b circumscribes the tumbler 102 and fluidly separates the air cavity 142b from a rear portion of the cabinet 100 where the air 12 is drawn into the tumbler 102 so that the air 12 is drawn into the tumbler 102 rather than directly into the air cavity 142b. A second seal or flange 146b circumscribes the tumbler 102 and fluidly separates the air cavity 142b from a front portion of the cabinet 100, such as at or near the door 114. Because the air 12 and particulates 14 flow from within the tumbler 102 and through the apertures 140b and the air cavity 142b toward the separation system 200b, the first seal 144b and the second seal 146b preclude particulates 14 from entering portions of the cabinet 100 other than the air cavity 142b (where the particulates 14 could clog or damage components of the laundry system 10b).

The separation system 200b is fluidly connected to the air cavity 142b and is disposed within the cabinet 100 beneath the tumbler 102. The fan 130b draws air 12 through the separation system 200b and thus encourages airflow from the tumbler 12, through the apertures 140b and the air cavity 142b to the separation system 200b. As discussed further below, the separation system 200b separates the particulates 14 from the airflow and directs the particulates 14 to the particulate hopper 300b.

In the illustrated example, the particulate hopper 300b is provided as a collection area beneath the tumbler 102 and is accessible for clearing by the user by removing the access panel 120b at the front side panel 104a of the cabinet 100. For example, the access panel 120b is affixed to the particulate hopper 300b so that the particulate hopper 300b and the access panel 120b may be extended from and/or removed from the laundry system 10b together and in tandem for emptying of the particulate hopper 300b.

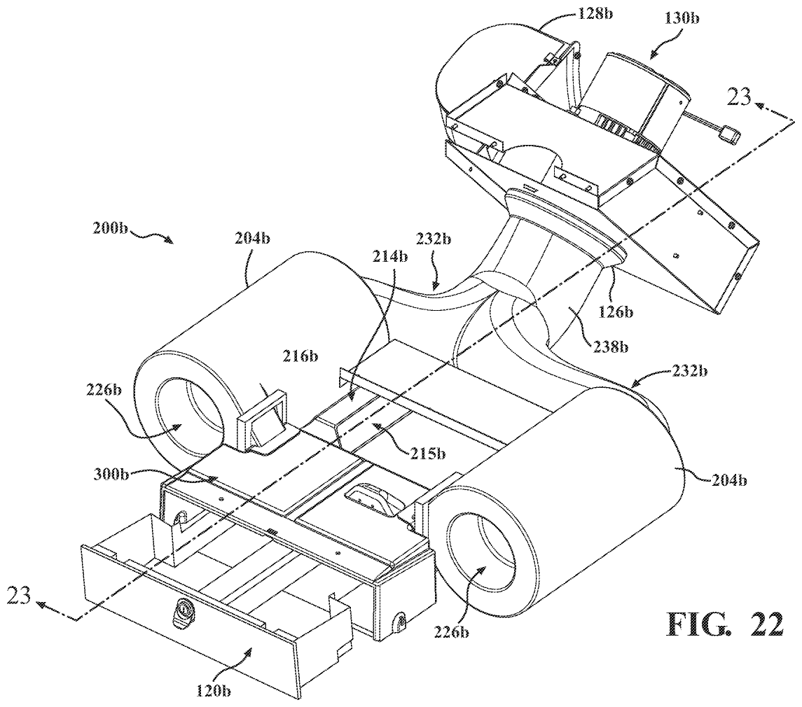

As shown in FIGS. 22-27C, the separation system 200b is disposed within the cabinet 100 below the tumbler 102 and thus is integrated with the cabinet 100 to remove particulates 14 from air 12 drawn through the cabinet 100 without use of a screen or conventional lint trap. The separation system 200b includes one or more cyclone filters 204b that are configured to receive incoming air 12 from the air cavity 142b and separately output particulates 14 and clean air 12C. In the illustrated example, the separation system 200b for each cabinet 100 includes two cyclone filters 204b, with air 12 drawn through both filters 204b in parallel by the fan 130b.

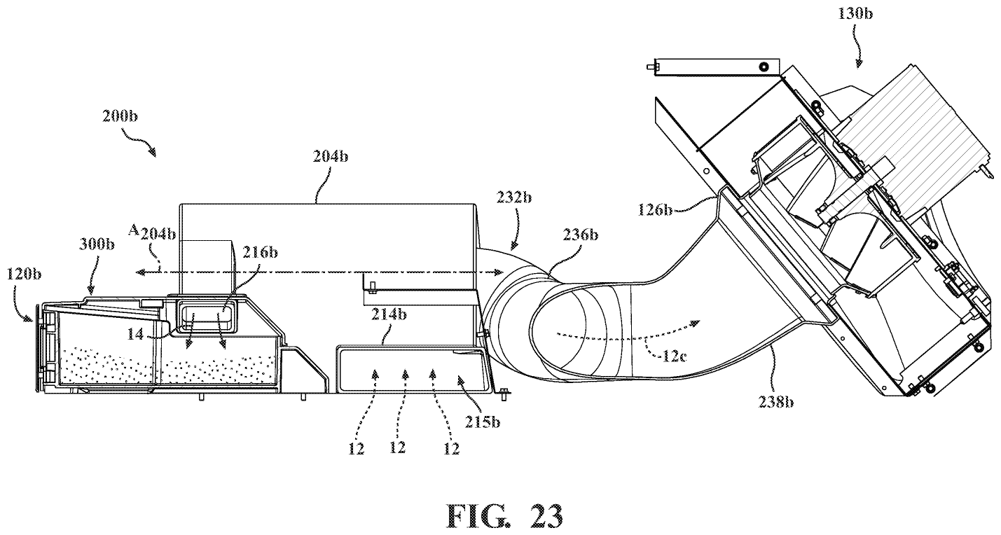

The cyclone filter 204b has a substantially cylindrical body 206b that extends between a first end 208b and a second end 210b to define a cyclone cavity 212b of the cyclone filter 204b. A central axis A_{204b} of the cyclone filter 204b extends along the cylindrical body 206b between the first end 208b and the second end 210b. As shown in FIGS. 20 and 23, the cyclone filter 204b extends substantially horizontally within the cabinet 100 so that the separation system 200b is accommodated within a compact space beneath the tumbler 102. That is, the central axis A_{204b} of the cyclone filter 204b extends substantially parallel to a ground surface at which the laundry system 10b is positioned or substantially perpendicular to the front side panel 104a and the rear side panel 104b.

The body 206b of the cyclone filter 204b includes an air inlet 214b disposed at the first end 208b of the body 206b that directs air 12 from the air cavity 142b into the cyclone cavity 212b, a particulate outlet 216b disposed at the second end 210b of the body 206b that directs particulates 14 removed from the air 12 toward the particulate hopper 300b, and a clean air outlet 218b formed at the first end 208b of the body 206b for the clean air 12C to exit the cyclone filter 204b. The air inlet 214b provides an inlet conduit 215b configured to introduce the air 12 into the cyclone cavity 212b in a substantially tangential manner relative to the body 206b and the central axis A_{204b}. Similarly, the particulate outlet 216b directs particulate 14 from the cyclone cavity 212b in a substantially tangential manner relative to the body 206b and the central axis A_{204b}, while the clean air outlet 218b is coaxial with the central axis A_{204b}.

In the illustrated example, the air inlet 214b extends tangentially from the cylindrical body 206b and along and substantially parallel to a bottom panel 104e of the cabinet 100 that forms a lower boundary of the air cavity 142b. The particulate outlet 216b extends tangentially from the cylindrical body 206b and is spaced from the bottom panel 104e of the cabinet 100 so as to direct particulate 14 into the particulate hopper 300b disposed above the bottom panel 104e. The particulate outlet 216b may be oriented at least partially downward toward the bottom panel 104e and may extend at least partially into the particulate hopper 300b to fluidly connect the cyclone cavity 212b and the particulate hopper 300b. Further, the air inlet 214b and the particulate outlet 216b may each have a substantially rectangular cross-section, where the cross-section of the air inlet 214b and conduit 215b is larger than the cross-section of the particulate outlet 216b so that the volume of air 12 entering the cyclone cavity 212b via the air inlet 214b is greater than the volume of particulate 14 exiting the cyclone cavity 212b via the particulate outlet 216b. In other words, a cross-section of the air inlet 214b is configured to provide a volume of air 12 to the cyclone cavity 212b sufficient to supply respective portions of the volume of air 12 to each of the particulate outlet 216b (i.e., dirty portion) and the clean air outlet 218b (i.e., clean portion). For example, the air inlet 214b includes a width W_{214b} that extends parallel to the central axis A_{204b} and the particulate outlet 216b includes a width W_{216b} that extends parallel the central axis A_{204b}, where the width W_{214b} of the air inlet 214b is greater than the width W_{216b} of the particulate outlet 216b.

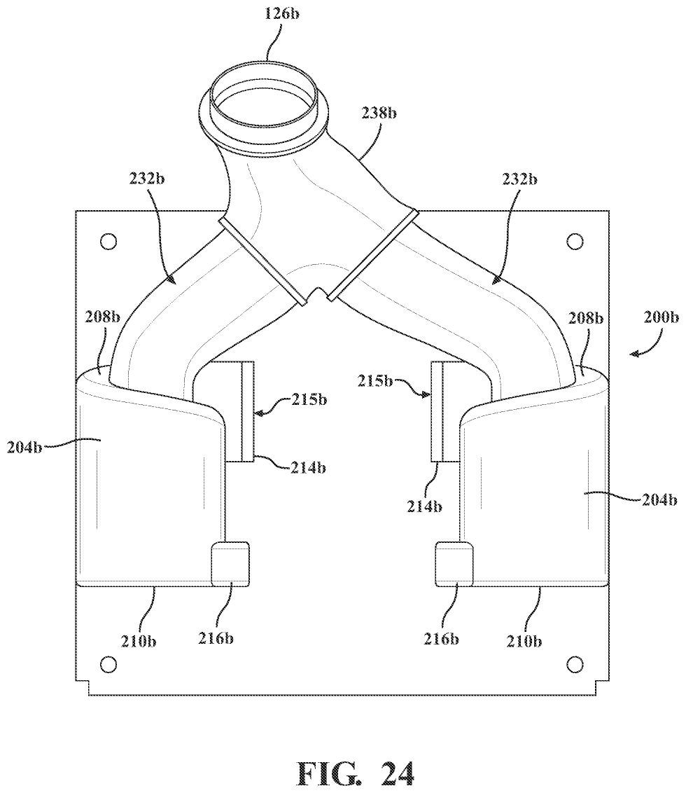

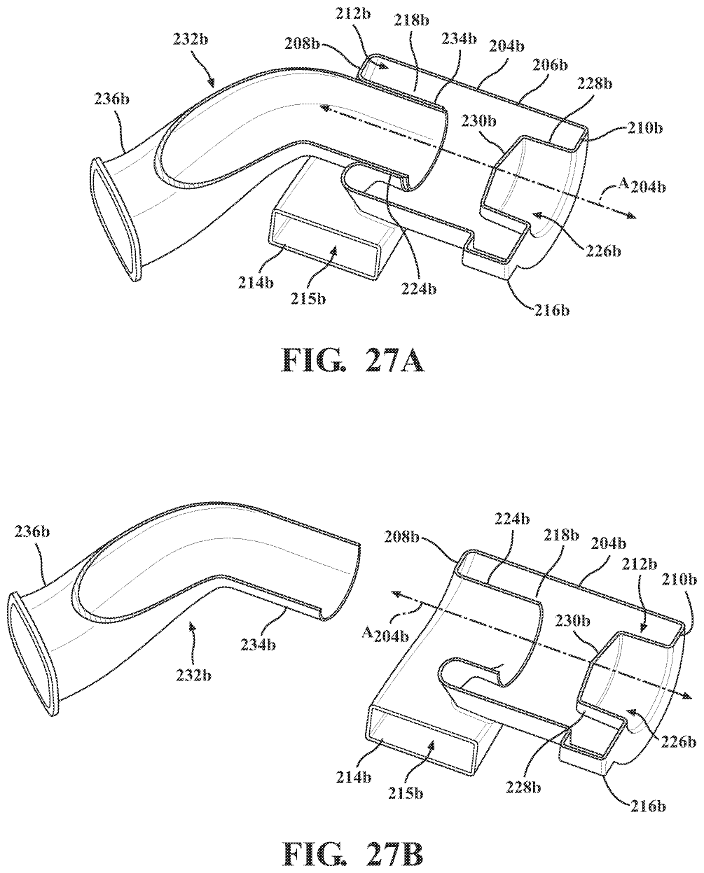

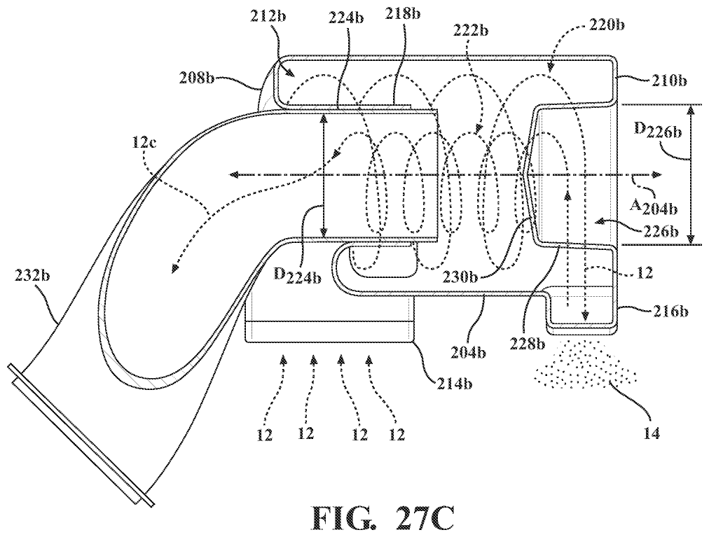

During operation of the laundry system 10b, air 12 is drawn from the air cavity 142b and through the inlet conduit 215b of the air inlet 214b into the cyclone cavity 212b. As shown in FIG. 24, the central axes A_{204b} of the two cyclone filters 204b are arranged parallel to one another, with the air inlet 214b of one cyclone filter 204b facing the air inlet 214b of the other cyclone filter 204b so that portions of the air 12 within the air cavity 142b flow into each cyclone filter 204b. In other words, the cyclone filters 204b are formed as mirror images of each other and are arranged on opposite sides of the air conduit 142b. The clean air outlet 218b extends axially along the central axis A_{204b} from the first end 208b of the body 206b such that air 12 is drawn along the inlet conduit 215b and at least partially around a cylindrical neck or vortex inducer 224b at the clean air outlet 218b when entering the body 206b. The width W_{214b} of the air inlet 214b may substantially correspond to or equal a length L_{224b} of the vortex inducer 224b along the central axis A_{204b} of the cyclone filter 204b. Thus, the inlet conduit 215b and the vortex inducer 224b cooperate to define a helical conduit for airflow to promote creation of an outer spiral vortex 220b of air 12 flowing from the air inlet 214b toward the particulate outlet 216b and the second end 210b of the body 206b (FIG. 27C).

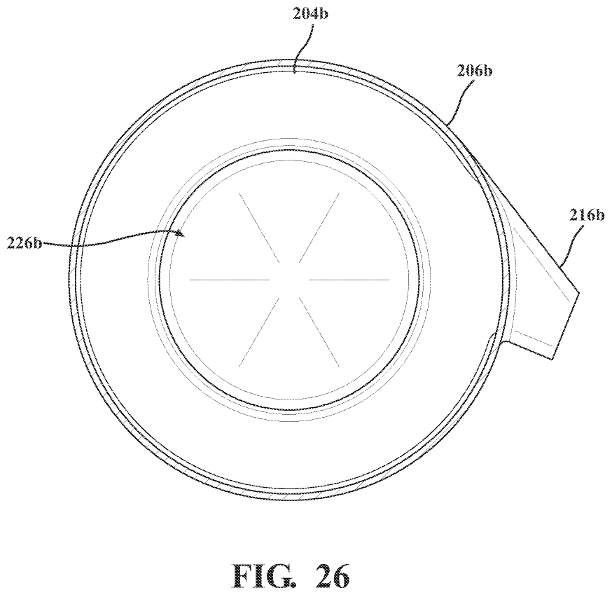

As the air 12 travels into the cyclone body 206b and forms the outer spiral vortex 220b flowing from the air inlet 214b toward the particulate outlet 216b, the particulate 14 experiences centrifugal forces that cause the particulate 14 to travel along the interior cylindrical surface of the body 206b. As shown in FIG. 26, the particulate outlet 216b is formed substantially tangential to the body 206b and the central axis A_{204b} to promote flow of the particulate 14 out of the outer spiral vortex 220b of air 12 and through the particulate outlet 216b to the particulate hopper 300b. In other words, because the cyclone filter 204b is oriented substantially horizontal (rather than vertical) and to allow for removal of the particulate 14 at the easy-to-access location of the particulate hopper 300b, the tangential particulate outlet 216b relies on the centripetal acceleration of the particulate 14 against the interior surface of the body 206b and the tangential, linear velocity of the particulate 14 when the particulate 14 arrives at the particulate outlet 216b. Particulate 14 is directed from the cyclone cavity 212b toward the particulate hopper 300b through the particulate outlet 216b in a generally downward and outward direction relative to the body 206b. That is, the particulate outlet 216b directs particulate 14 in a direction that is at least partially downward and away from the cyclone filter 204b.

To prevent movement of the outer spiral vortex 220b beyond the particulate outlet 216b at the second end 210b of the body 206b (which could result in recapture of the particulate 14 into the airflow), a vortex diverter 226b extends from the interior surface at the second end 210b of the body 206b and along the central axis A_{204b} toward the first end 208b. The vortex diverter 226b includes an outer diverter wall 228b that has a length L_{228b} extending from a first end attached to the second end 210b of the body 206b to a distal second end. As shown, the length L_{228b} of the diverter wall 228b is greater than the width W_{216b} of the particulate outlet 216b. The diverter wall 228b of the vortex diverter 226b is concentric with the central axis A_{204b} and the clean air outlet 218b. The diverter wall 228b has an outer diameter D_{226b} that tapers from the first end of the diverter wall 228b to the second end of the diverter wall 228b, and that is at least slightly larger than an inner diameter D_{218b} of the clean air outlet 218b at the second end of the diverter wall 228b. A conical cap 230b is disposed at the second end of the diverter wall 228b. As the airflow of the outer spiral vortex 220b approaches the second end 210b and the vortex diverter 226b, the vortex diverter 226b helps to separate the particulate 14 from the airflow and to promote an interior airflow or inner spiral vortex 222b of clean air 12C along the central axis A_{204b} and toward the clean air outlet 218b.

Thus, instead of using a long, tapered outer cylinder to allow the air vortex to turn and exit the filter, the vortex diverter 226b includes the cylindrical or conical diverter wall 228b that extends within the cyclone cavity 212b from the second end 210b of the body 206b and that has the diameter D_{228b} that is slightly larger than the diameter D_{218b} of the clean air outlet 218b or vortex inducer 224b. This geometry influences the direction of the airflow when entering the air inlet 214b and the cyclone body 206b along the vortex inducer 224b. Moreover, the vortex diverter 226b allows the body 206b to be shortened along the central axis A_{204b} relative to cyclone designs without a vortex diverter to further reduce the packaging requirements of the separation system 200b within the cabinet 100.

With the fan 130b operating to draw airflow from the filter 204b through the clean air outlet 218b, the inner spiral vortex 222b of clean air 12C flows within (i.e., radially inwardly of) the outer spiral vortex 220b and through the clean air outlet 218b at the first end 208b of the body 206b. As shown in FIGS. 27A-27C, a clean air conduit 232b is connected between the fan 130b and the clean air outlet 218b so that clean air 12C flows from the cyclone filter 204b toward the fan 130b to be exhausted from the laundry system 10b and/or reintroduced to the cabinet 100. The clean air conduit 232b includes a cylindrical mating portion 234b that is at least partially received along the clean air outlet 218b and an angled or curved or twisted portion 236b extending from the mating portion 234b toward the fan 230b.

In the illustrated example, the clean air conduit 232b is manufactured separately from the cyclone filter 204b and mated with the filter 204b at the clean air outlet 218b during assembly to provide for simpler manufacturing and easier assembly of the separation system 200b. However, it should be understood that the clean air conduit 232b and the filter 204b may be integrally formed with one another. Further, mating the mating portion 234b of the clean air conduit 232b with the cylindrical clean air outlet 218b of the filter 204b allows the axial or rotational position of the end of the vortex inducer 224b to be adjusted and set relative to the vortex divider 226b. That is, in some implementations, the mating portion 234b of the clean air conduit 232b may extend into the cavity 212b beyond an end of vortex inducer 224b so that an outer surface of the mating portion 234b operates to extend the vortex inducer 224b into the cavity 212b.

Moreover, because the clean air outlet 218b is disposed axially inwardly of the first end 208b of the body 206b along the central axis A_{204b} and the mating portion 234b of the clean air conduit 232b extends along the vortex inducer 224b to the clean air outlet 218b, the curved portion 236b of the clean air conduit 232b extends from the mating portion 234b at or near the first end 208b of the body 206b. That is, the geometry of the body 206b and clean air conduit 232b allows the clean air conduit 232b to turn or curve closer to the body 206b than would be possible with an integrally formed conduit. This allows for a compact airflow solution without adding flow restriction or causing the airflow to turn at sharp angles.

As shown in FIGS. 22 and 24, the clean air conduits 232b connected to the parallel filters 204b are connected to the fan 130b via a two-way manifold or adapter 238b so that, when the fan 130b is operated to draw airflow through the separation system 200b, air 12 is drawn in parallel through the separate filters 204b. The particulate outlets 216b of the parallel filters 204b deposit particulate 14 into a shared particulate hopper 300b disposed between the filters 204b. It should be understood that the fan 130b may be fluidly connected to any number of filters 204b via a differently configured adapter. For example, the fan 130b may be fluidly connected to the separation system 200b servicing the upper cabinet 100 and the separation system 200b servicing the lower cabinet 100.

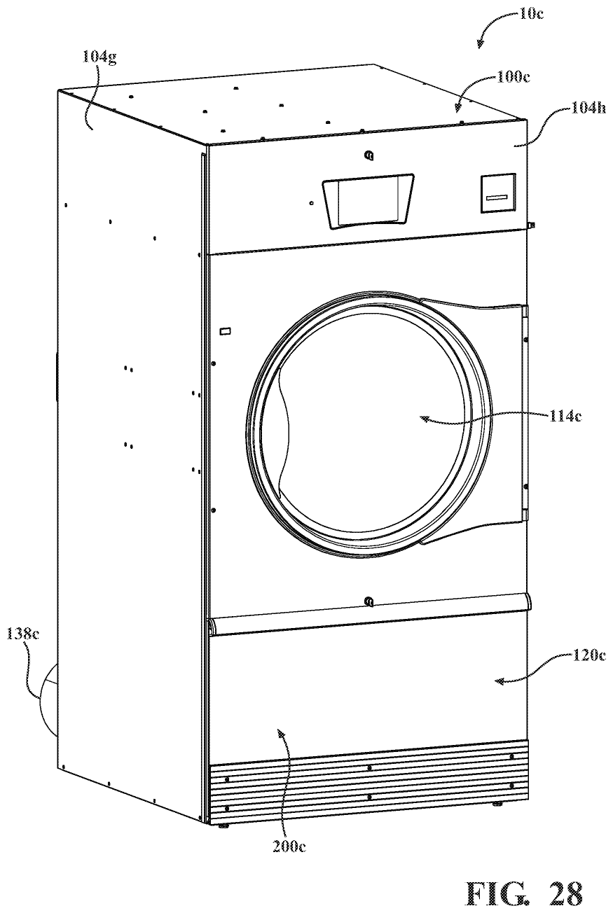

Referring to FIGS. 28-32, another example of the laundry system 10c is provided including implementations of alternative configurations of the cabinet 100c and the particulate separation system 200c disposed within the particulate hopper 300c. In view of the substantial similarity in structure and function of the components associated with the laundry systems 10, 10a, and 10b with respect to the laundry system 10c, like reference numerals containing letter extensions are used to identify those components that have been modified.

As shown in FIGS. 28-32, the laundry system 10c includes a cabinet 100c having a single tumbler 102c. The cabinet 100c includes a first, front side panel 104e, a second, rear side panel 104f disposed on an opposite side (i.e., a back side) of the cabinet 100c than the front side panel 104e. A third side panel 104g and a fourth side panel 104h each extend between the front side panel 104e and the rear side panel 104f such that the side panels 104e-104h collectively define a cavity 106c in which the tumbler 102c is disposed. In addition to a door 114c mounted to an opening in the front side panel 104e, the cabinet 100c includes the control board 116 including the user interface 118, as discussed previously.

The cabinet 100c further includes an access panel 120c removably attached at a lower portion of the cabinet 100c (i.e., below the tumbler cavity 106c). The access panel 120c is configured to be selectively removed from and replaced on the front side panel 104e to expose and conceal the particulate hopper 300c. Optionally, the access panel 120c may include an electronic lock. When the particulate hopper 300c is full and needs to be emptied, the control board 116c may send a signal (e.g., in response to a user selecting a cleanout notification) to the actuator to unlock/open the access panel 120c for opening by a user. In other implementations, a user may manually unlock the access panel 120c using a manual locking or latching device.

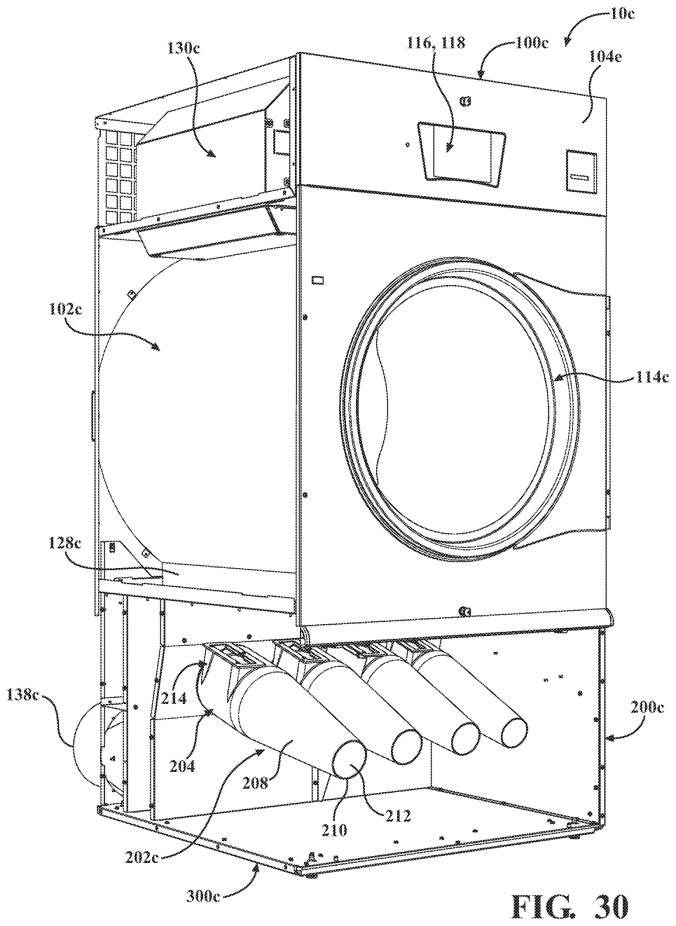

Referring to FIGS. 30 and 32, the laundry system 10c includes a tumbler exhaust duct 128c connecting the cabinet 100c to the particulate hopper 300c and the particulate separation system 200c. As described above, in some examples of the disclosure, the particulate hopper 300c and the particulate separation system 200c are integrated with the cabinet 100c. For instance, as shown in FIG. 32, particulate hopper 300c and the particulate separation system 200c are positioned below the cabinet 100c and the tumbler exhaust duct 128c provides fluid communication between the cavity 106c of the cabinet 100c and particulate separation system 200c.

As discussed previously with respect to the cabinet 100b, the cabinet 100c may include an air cavity encompassing at least a portion of the tumbler 102c, such as a forward portion of the tumbler 102c toward the door 114c, so that the tumbler 102c rotates or spins within the air cavity. Similar to the configuration shown in FIG. 21, a first seal circumscribes the tumbler 102c and fluidly separates the air cavity from a rear portion of the cabinet 100c where the air 12 is drawn into the tumbler 102 so that the air 12 is drawn into the tumbler 102c rather than directly into the air cavity. A second seal or flange circumscribes the tumbler 102c and fluidly separates the air cavity from a front portion of the cabinet 100, such as at or near the door 114. Thus, air 12 and particulates 14 are directed from the tumbler 102c to the tumbler exhaust duct 128c via the air cavity formed around the tumbler 102c.

Referring still to FIGS. 28-32, the particulate separation system 200c removes particulates 14 from the air 12 flowing from the cabinet 100c, where the removed particulates 14 are collected by the particulate hopper 300b disposed beneath the particulate separation system 200c while clean air 12 is drawn upward. Like the particulate separation systems 200, 200a, 200b described previously, the particulate separation system 200b may operate entirely without a screen.

As best shown in FIG. 32, the particulate separation system 200c is mounted within the particulate hopper 300c to limit the effect of outside ambient air on the particulate separation system 200c. In other words, incorporating the particulate separation system 200c within the particulate hopper 300c insulates the particulate separation system 200c from ambient air, which, in turn, reduces the amount of moisture within the particulate separation system 200c and the particulate hopper 300c. For instance, cyclone filters 204 of the particulate separation system 200c are surrounded by a volume of relatively warm air contained within the particulate hopper 300c such that the cyclone filters 204 themselves are maintained at a warmer temperature than if the cyclone filters 204 are exposed to ambient air. By maintaining the cyclone filters 204 at the warmer temperature, the relatively moist air passing through the cyclone filters 204 is less likely to condense on the walls of the cyclone filter 204, thereby minimizing the introduction of moisture into the particulates 14.

Referring now to FIGS. 28-32, the particulate hopper 300c includes one or more panels that define a hopper cavity 304c that collects the removed particulates 14 from the particulate separation system 200c. While the particulate hopper 300c may include separate panels similar to the panels 302a-302g discussed above, the illustrated example is provided with the particulate hopper 300c defined by the panels 104e-104h of the cabinet 100c. Thus, the particulate hopper 300c may be provided as an integrated portion with the cabinet 100c.

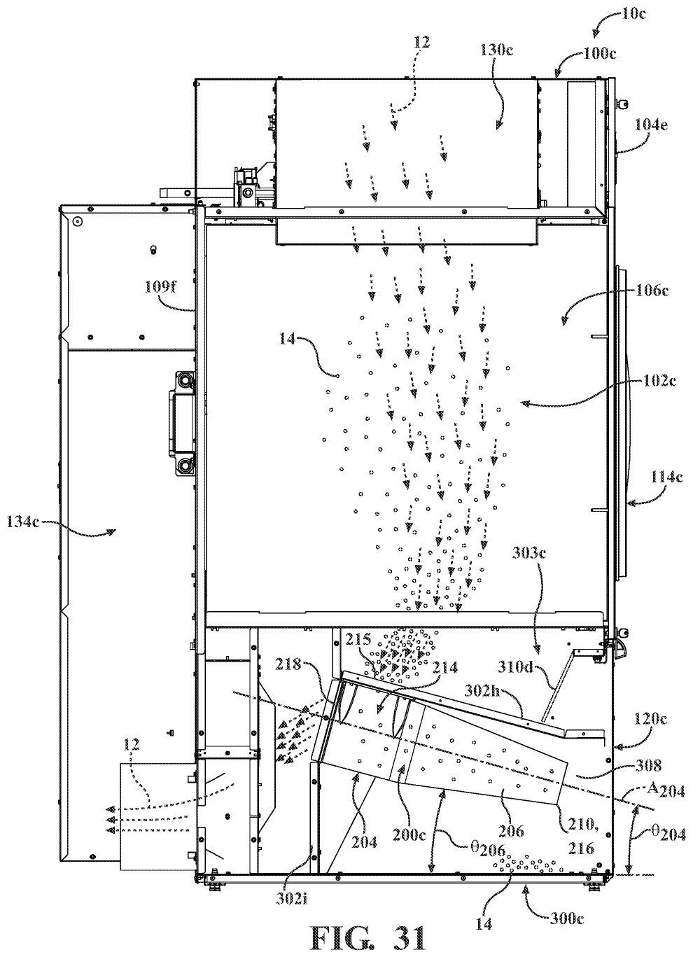

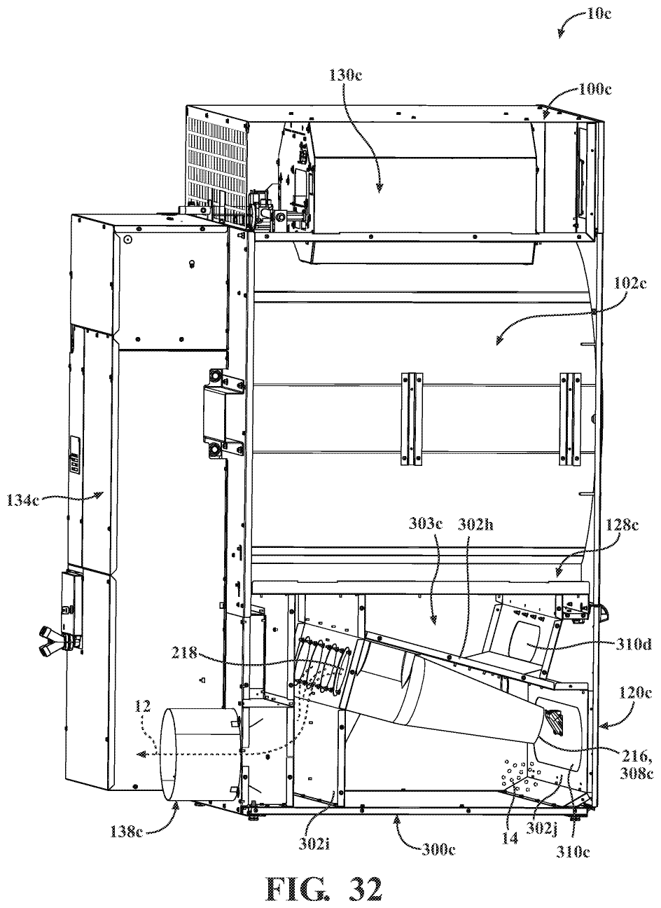

In the illustrated example, the particulate hopper 300c includes an optional intermediate hopper cleanout cavity or duct 303c positioned between the tumbler exhaust duct 128c and the hopper cavity 304c. As best shown in FIGS. 31 and 32, the intermediate cleanout cavity 303c is separated from the hopper cavity 304c by an intermediate hopper cavity panel 302h, which generally extends between a rear hopper wall 302i and the front side panel 104e to define the intermediate cleanout cavity 303c and the hopper cavity 304c disposed below the intermediate cleanout cavity 303c. As shown, the intermediate hopper cavity panel 302h is oriented an oblique angle sloping downwardly along a direction from the rear hopper wall 302i to the front side panel 102e. The intermediate cleanout cavity 303c further includes an intermediate cleanout access panel 310d defining an opening at a front portion of the intermediate cleanout cavity 303c. Thus, larger objects and debris that are removed from the tumbler 102c in the flow of air 12 may drop into the intermediate cleanout cavity 303c upstream of the particulate separation system 200c, whereby the objects can be accessed and removed through the intermediate cleanout access panel 310d and do not enter the particulate separate system 200c.

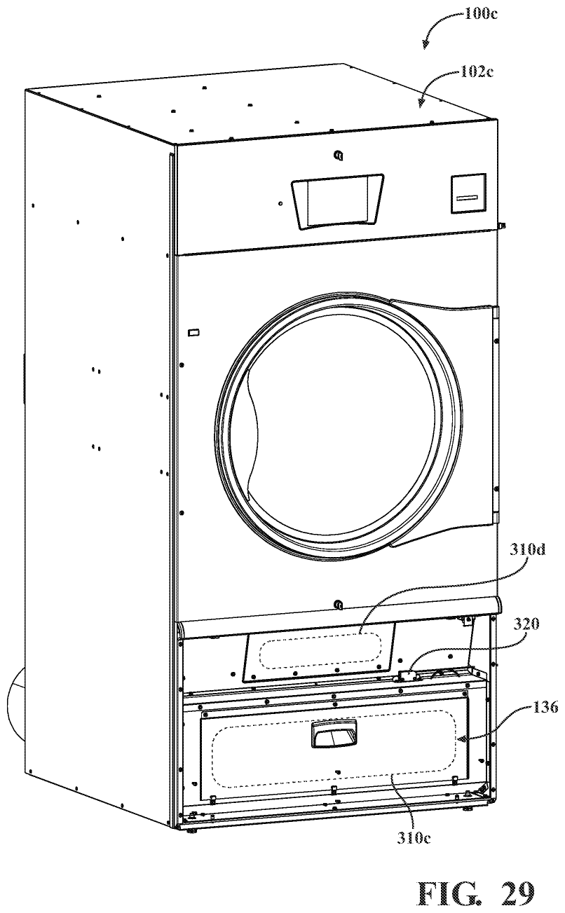

Referring still to FIGS. 29, 31, and 32, the hopper cavity 304c is disposed below the intermediate cleanout cavity 303c. However, it should be appreciated that the particulate hopper 300c may be provided without the intermediate cleanout cavity 303c, whereby the hopper cavity 304c is in direct communication with the tumbler exhaust duct 128c. In the illustrated example, the hopper cavity 304c is disposed between the rear hopper wall 302i and a front hopper wall 302j (FIG. 32). The front hopper wall 302j may include a hopper cleanout opening and access panel 310c configured to provide access to the hopper cavity 304c when the cabinet access panel 120c is removed.

Referring still to FIGS. 30-32, the particulate separation system 200c is configured in a substantially similar manner as the particulate separation systems 200, 200a discussed previously. Particularly, the particulate separation system 200c includes a cyclonic separation system 202c including a plurality of the cyclone filters 204 described previously with respect to FIGS. 10 and 11. Accordingly, the details of the cyclone filters 204 discussed previously are incorporated in the cyclone filters 204 of the cyclonic separation system 202c. In the illustrated example, the cyclone filters 204c are disposed within the hopper cavity 304 such that the axes A₂₀₄ of the cyclone filters 204 are arranged at an oblique angle relative to vertical or horizontal. For avoidance of doubt, the axes A₂₀₄ of the cyclone filters 204 are oriented at an oblique angle θ₂₀₄ (FIG. 31) relative to a horizontal base of the laundry system 10c, whereby a bottom portion of the conical body 206 of each cyclone filter 204 is also oriented at an oblique angle θ₂₀₆ (FIG. 31) to provide a continuous decline from the air inlet 214 to the outlet 216.

As best shown in FIG. 31, each of the cyclone filters 204 is disposed adjacent to the intermediate hopper cavity panel 302h, whereby the inlet 214 and the conduit 215 are in communication with the tumbler exhaust duct 128c and receive a mixture of air 12 and particulates 14 from the tumbler 102c. The air 12 and particulate 14 mixture is filtered through the cyclone filter 204 in a similar manner as discussed above, whereby particulates 14 are removed from the air 12 via centripetal acceleration and drop into the hopper cavity 304c from the particulate outlet 216. Optionally, the hopper cavity 304c may include a panel or channels defining a particulate inlet 308c of the hopper cavity 304c. Clean air 12 is exhausted from each of the cyclone filters 204 via the clean air outlet 218, which is disposed adjacent to the rear hopper wall 302i (FIG. 31). The clean air 12 is then directed out through the system exhaust 138c.

The particulate hopper 300a further includes one or more capacity sensors 320 in communication with the control board 116 and configured to measure a capacity of the hopper cavity 304c of the particulate hopper 300c. As shown in FIG. 29, a capacity sensor 320 is mounted in an upper portion of the particulate hopper 300c, above the hopper cavity cleanout port 310c. The capacity sensor 320 measures the available capacity of the hopper cavity 304c and sends a signal to the control board 116, which in response to determining the capacity of the particulate hopper 304c has exceeded a fill threshold, sends a signal indicating that the particulate hopper cavity 304c needs to be emptied. Here, the fill threshold may be configured by a user of the user interface 118. For example, a user may select a capacity that is an acceptable threshold for the particulate hopper 300c, where the control board 116 generates a notification (e.g., warning light, alarm) in response to detecting the capacity of the particulate hopper 304c has exceeded the fill threshold configured by the user. In other examples, the fill threshold is configured by the manufacturer of the laundry system 10c (e.g., on a regular schedule to ensure maximum performance).

In some examples, the user accesses the hopper cavity 304c by removing the access panel 120c on the front of the cabinet 100c to reveal the access port 108, and can affix a vacuum to the cleanout opening of the access panel 310c to vacuum the particulates 14 from the particulate hopper 300c disposed below the cabinet 100c. The control board 116 may send a signal to an actuator of the access control 136 in response to receiving an indication that the user has addressed a cleanout indication displayed on the user interface 118 of the control board 116.

Optionally, the laundry system 10c includes one or more of the temperature sensors 16 configured to measure a temperature of the laundry system 10a and communicate the measured temperature to the control board 116a. The control board 116 is configured to evaluate the measured temperature to detect operating conditions of the laundry system 10c. For example, a relatively high measured temperature detected by the control board 116 may correspond to blockage in the exhaust 138c of the laundry system 10c. Here, the control board 116 may instruct the fan 130 to increase speed clear the blockage. The one or more temperature sensors 16 may be located in any combination of the air passageways in the laundry system 10, such as the cavity 106c of the cabinet 100c, the tumbler exhaust duct 128, the particulate hopper 300c, and/or the housing 134 of the fan 130. Here, the control board 116 may execute (e.g., via the data processing hardware 122) a fan algorithm to optimize a variable speed of the fan 130 based on the one or more temperature readings measured by the temperature sensors 16 located in the laundry system 10c. In other words, the control board 116 may increase a speed of the fan 130 in response to determining, using the fan algorithm, that the detected temperature of the laundry system 10c has exceeded a temperature threshold.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

What is claimed is:

1. A cyclone filter comprising:
a body including a cylindrical surface extending between a first end and a second end, the body defining a cavity of the cyclone filter;
an air inlet formed through the cylindrical surface, the air inlet configured to receive an airflow from a laundry cabinet and to direct the airflow along the cylindrical surface within the cavity;
a vortex diverter extending within the cavity from the second end of the body, the vortex diverter configured to interrupt the airflow as it passes within the cavity between the vortex diverter and the cylindrical surface to separate particulates from the airflow; and
a particulate outlet formed through the cylindrical surface and axially spaced from the air inlet, the particulate outlet configured to direct particulates separated from the airflow toward a particulate receptacle.

2. The cyclone filter of claim 1, wherein a vortex inducer extends within the cavity from the first end and at least partially along the cylindrical surface of the body, the vortex inducer comprising a cylindrical surface and configured to direct the airflow from the air inlet in a helical spiral between the cylindrical surface of the body and the cylindrical surface of the vortex inducer.

3. The cyclone filter of claim 2, wherein the vortex diverter comprises an annular surface extending from the second end of the body, the annular surface of the vortex diverter having a first outer diameter that is greater than a second outer diameter of the cylindrical surface of the vortex inducer.

4. The cyclone filter of claim 1, wherein a clean air outlet is formed through the first end of the body, the clean air outlet configured to receive clean air drawn from the cavity.

5. The cyclone filter of claim 4, wherein an opening of the clean air outlet is between the air inlet and the first end of the body.

6. The cyclone filter of claim 4, wherein a clean air conduit extends through the clean air outlet and at least partially within the cavity.

7. The cyclone filter of claim 6, wherein the clean air conduit comprises a cylindrical portion that extends through the clean air outlet and at least partially within the cavity and a curved portion that extends at an oblique angle between the cylindrical portion and an airflow source.

8. The cyclone filter of claim 1, wherein the air inlet comprises a conduit that extends tangential to the cylindrical surface of the body.

9. The cyclone filter of claim 1, wherein the particulate outlet comprises a conduit that extends tangential to the cylindrical surface of the body.

10. The cyclone filter of claim 1, wherein a central axis of the cyclone filter extends between the first end and the second end, the air inlet and the particulate outlet formed through the cylindrical surface tangential relative to the central axis.

11. A laundry system comprising:
a cabinet including a tumbler for processing laundry and an access port extending through the cabinet;
a particulate separation system for removing particulates from air in the tumbler; and
a particulate hopper configured to collect the removed particulates and including a cleanout port cooperating with the access port of the cabinet to provide access for removing the collected removed particulates from the particulate hopper.

12. The laundry system of claim 11, wherein the cabinet further includes a front side panel and a rear side panel disposed on a different side of the cabinet than the front side panel, the access port extending from the front side panel to the rear side panel.

13. The laundry system of claim 11, wherein at least a portion of the particulate hopper is disposed below an outlet of the particulate separation system.

14. The laundry system of claim 11, wherein at least a portion of the particulate separation system is disposed within the particulate hopper.

15. The laundry system of claim 11, wherein the particulate separation system includes a cyclonic separation system.

16. The laundry system of claim 11, wherein the cyclonic separation system is integrated with the cabinet.

17. The laundry system of claim 15, wherein the cyclonic separation system includes an array of one or more cyclone filters.

18. The laundry system of claim 11, wherein the particulate separation system comprises:
a body including a cylindrical surface extending between a first end and a second end, the body defining a cavity of the cyclone filter;
an air inlet formed through the cylindrical surface, the air inlet configured to receive an airflow from the laundry cabinet and to direct the airflow along the cylindrical surface within the cavity;
a vortex diverter extending within the cavity from the second end of the body, the vortex diverter configured to interrupt the airflow as it passes within the cavity between the vortex diverter and the cylindrical surface to separate particulates from the airflow; and
a particulate outlet formed through the cylindrical surface and axially spaced from the air inlet, the particulate outlet configured to direct particulates separated from the airflow toward the particulate receptacle.

19. The laundry system of claim 18, wherein a vortex inducer extends within the cavity from the first end and at least partially along the cylindrical surface of the body, the vortex inducer comprising a cylindrical surface and configured to direct the airflow from the air inlet in a helical spiral between the cylindrical surface of the body and the cylindrical surface of the vortex inducer.

20. The laundry system of claim 19, wherein the vortex diverter comprises an annular surface extending from the second end of the body, the annular surface of the vortex diverter having a first outer diameter that is greater than a second outer diameter of the cylindrical surface of the vortex inducer.
